(19) United States
(12) Patent Application Publication
(10) Pub. No.: US 2017/0259572 A1
(43) Pub. Date: Sep. 14, 2017

(54) LIQUID EJECTION DEVICE, METHOD OF MANUFACTURING LIQUID EJECTION DEVICE, AND PRINTER

(71) Applicant: CANON KABUSHIKI KAISHA

(72) Inventors: Junri Ishikura, Tokyo (JP); Norihiko Ochi, Kawasaki-shi (JP)

(21) Appl. No.: 15/506,517

(22) PCT Filed: Sep. 9, 2015
(86) PCT No.: PCT/JP2015/004589

§ 371 Date: Feb. 24, 2017

(30) Foreign Application Priority Data
Sep. 11, 2014 (JP) 2014-184814

(51) Int. Cl. B41J 2/16

(52) U.S. Cl. CPC B41J 2/1609; B41J 2/1623; B41J 2002/14491

(57) ABSTRACT

In order to provide a liquid ejection device capable of ejecting a minute liquid droplet with stability, an end surface of a first partition portion is fixed to a plate with a first adhesive layer, an end surface of a second partition portion is fixed to the plate with a second adhesive layer, and an elastic coefficient of the first adhesive layer is smaller than an elastic coefficient of the second adhesive layer.

### TECHNICAL FIELD

The present invention relates to a liquid ejection device, a method of manufacturing a liquid ejection device, and a printer.

### BACKGROUND ART

A liquid ejection device (liquid ejection head) is configured to change liquid pressure in a region filled with liquid (pressure chamber) to eject liquid from a discharge port. A drop-on-demand liquid ejection device is most generally widespread. Further, systems for applying pressure to liquid are broadly divided into two systems. One of the systems is a system in which a capacity of the pressure chamber is changed by applying a drive signal to a piezoelectric element to displace the piezoelectric element, to thereby apply pressure to liquid. The other of the systems is a system in which a resistor produces heat by a drive signal applied to the resistor to generate an air bubble in the pressure chamber, to thereby apply pressure to liquid.

The liquid ejection device using the piezoelectric element can be manufactured relatively easily by mechanically processing a bulk piezoelectric material. Further, the liquid ejection device using the piezoelectric element is also advantageous in that there are few restrictions imposed on a kind of liquid and that liquid containing various materials can be ejected. From such a viewpoint, in recent years, there is an increase in attempts to use the liquid ejection device using the piezoelectric element for an industrial purpose such as manufacture of a color filter or formation of wiring.

Further, a technology involving changing a capacity of a pressure chamber (liquid channel) by displacing a partition formed of a piezoelectric material in a shear mode, to thereby eject liquid, can precisely control the capacity change of the pressure chamber, and thus has attracted great attention (see PTL 1).

Further, in recent years, there is a demand to eject a minute liquid droplet. For example, liquid ejection on the order of picoliters is required. Further, liquid ejection even on the order of subpicoliters or smaller is required.

### CITATION LIST

### Patent Literature

PTL 1: Japanese Examined Patent Publication No. H06-6375
PTL 2: Japanese Patent Application Laid-Open No. 2003-165220
PTL 3: Japanese Patent Application Laid-Open No. 2007-38654

### SUMMARY OF INVENTION

### Technical Problem

However, it is not necessarily easy to eject a minute liquid droplet with stability.

It is an object of the present invention to provide a liquid ejection device capable of ejecting a minute liquid droplet with stability.

### Solution to Problem

According to one aspect of an embodiment, a liquid ejection device, including: a base including: a first piezoelectric body; and a second piezoelectric body fixed to the first piezoelectric body and polarized in a direction opposite to a polarization direction of the first piezoelectric body; a pressure chamber formed to the base and separated by at least two partitions formed of the first piezoelectric body and the second piezoelectric body and by a plate mounted on end surfaces of the at least two partitions; and an electrode formed on both side surfaces of the at least two partitions, wherein: the pressure chamber is narrow on a front surface side on which a discharge port configured to eject liquid is formed; a surface of the at least two partitions that faces the pressure chamber includes: a first partition portion formed of only the first piezoelectric body; and a second partition portion formed of the first piezoelectric body and the second piezoelectric body; the pressure chamber is separated by the first partition portion on the front surface side; the pressure chamber is separated by the second partition portion on a back surface side on which a liquid chamber configured to supply the liquid to the pressure chamber is formed; the end surface of the first partition portion is fixed to the plate with a first adhesive layer; the end surface of the second partition portion is fixed to the plate with a second adhesive layer; and an elastic coefficient of the first adhesive layer is smaller than an elastic coefficient of the second adhesive layer.

According to another aspect of the embodiment, a liquid ejection device, including: a base including: a first piezoelectric body; and a second piezoelectric body fixed to the first piezoelectric body and polarized in a direction opposite to a polarization direction of the first piezoelectric body; a pressure chamber formed to the base and separated by at least two partitions formed of the first piezoelectric body and the second piezoelectric body and by a plate mounted on end surfaces of the at least two partitions; and an electrode formed on both side surfaces of the at least two partitions, wherein: the pressure chamber is narrow on a front surface side on which a discharge port configured to eject liquid is formed; a surface of the at least two partitions that faces the pressure chamber includes: a first partition portion formed of only the first piezoelectric body; and a second partition portion formed of the first piezoelectric body and the second piezoelectric body; the pressure chamber is separated by the first partition portion on the front surface side; the pressure chamber is separated by the second partition portion on a back surface side on which a liquid chamber configured to supply the liquid to the pressure chamber is formed; the end surface of the first partition portion is fixed to the plate with a first adhesive layer; the end surface of the second partition portion is fixed to the plate with a second adhesive layer; and a thickness of the first adhesive layer is larger than a thickness of the second adhesive layer.

According to further another aspect of the embodiment, a method of manufacturing a liquid ejection device, including: forming a groove in a first piezoelectric body and a second piezoelectric body fixed to the first piezoelectric body and polarized in a direction opposite to a polarization direction of the first piezoelectric body, to thereby form a pressure chamber separated by a partition including a first partition portion obtained by cutting up to the first piezoelectric body and a second partition portion obtained by cutting from the first piezoelectric body up to the second piezoelectric body; forming an electrode on the partition; and bonding a plate to the partition, wherein the bonding of the plate includes: bonding the plate to the first partition portion with a first adhesive; and bonding the plate to the second partition portion with a second adhesive.

According to further another aspect of the embodiment, a printer, including the above mentioned liquid ejection device.

Further features of the present invention will become apparent from the following description of exemplary embodiments with reference to the attached drawings.

### BRIEF DESCRIPTION OF DRAWINGS

FIG. 1 is an exploded perspective view for schematically illustrating a liquid ejection device according to an embodiment of the present invention.

FIG. 2 is a sectional view for illustrating a part of a piezoelectric transducer of the liquid ejection device according to the embodiment of the present invention.

FIG. 3 is a perspective view for illustrating a part of the piezoelectric transducer of the liquid ejection device according to the embodiment of the present invention.

FIG. 4 is a perspective view for illustrating a part of the piezoelectric transducer of the liquid ejection device according to the embodiment of the present invention.

FIG. 5A is a sectional view for illustrating parts of the piezoelectric transducer of the liquid ejection device according to the embodiment of the present invention.

FIG. 5B is a sectional view for illustrating parts of the piezoelectric transducer of the liquid ejection device according to the embodiment of the present invention.

FIG. 6A is a perspective view for illustrating parts of the piezoelectric transducer of the liquid ejection device according to the embodiment of the present invention.

FIG. 6B is a perspective view for illustrating parts of the piezoelectric transducer of the liquid ejection device according to the embodiment of the present invention.

FIG. 7A is a sectional view for illustrating displacement of a partition of the piezoelectric transducer of the liquid ejection device according to the embodiment of the present invention.

FIG. 7B is a sectional view for illustrating displacement of a partition of the piezoelectric transducer of the liquid ejection device according to the embodiment of the present invention.

FIG. 8A is a sectional view for illustrating the displacement of the partition of the piezoelectric transducer of the liquid ejection device according to the embodiment of the present invention.

FIG. 8B is a sectional view for illustrating the displacement of the partition of the piezoelectric transducer of the liquid ejection device according to the embodiment of the present invention.

FIG. 9A is a sectional view for illustrating the displacement of the partition of the piezoelectric transducer of the liquid ejection device according to the embodiment of the present invention.

FIG. 9B is a sectional view for illustrating the displacement of the partition of the piezoelectric transducer of the liquid ejection device according to the embodiment of the present invention.

FIG. 10A is a sectional view for illustrating an operation of the piezoelectric transducer of the liquid ejection device according to the embodiment of the present invention.

FIG. 10B is a sectional view for illustrating an operation of the piezoelectric transducer of the liquid ejection device according to the embodiment of the present invention.

FIG. 10C is a sectional view for illustrating an operation of the piezoelectric transducer of the liquid ejection device according to the embodiment of the present invention.

FIG. 10D is a sectional view for illustrating an operation of the piezoelectric transducer of the liquid ejection device according to the embodiment of the present invention.

FIG. 10E is a sectional view for illustrating an operation of the piezoelectric transducer of the liquid ejection device according to the embodiment of the present invention.

FIG. 11 is a process view for illustrating a method of manufacturing a liquid ejection device according to the embodiment of the present invention.

FIG. 12 is a process view for illustrating the method of manufacturing a liquid ejection device according to the embodiment of the present invention.

FIG. 13 is a process view for illustrating the method of manufacturing a liquid ejection device according to the embodiment of the present invention.

FIG. 14 is a process view for illustrating the method of manufacturing a liquid ejection device according to the embodiment of the present invention.

FIG. 15 is a process view for illustrating the method of manufacturing a liquid ejection device according to the embodiment of the present invention.

FIG. 16 is a process view for illustrating the method of manufacturing a liquid ejection device according to the embodiment of the present invention.

FIG. 17A is a sectional view for illustrating parts of a piezoelectric transducer of a liquid ejection device according to a modification example of the embodiment of the present invention.

FIG. 17B is a sectional view for illustrating parts of a piezoelectric transducer of a liquid ejection device according to a modification example of the embodiment of the present invention.

FIG. 18 is a process view for illustrating a method of manufacturing a liquid ejection device according to the modification example of the embodiment of the present invention.

FIG. 19 is a perspective view for illustrating a part of a piezoelectric transducer of a liquid ejection device according to Example 1 of the present invention.

FIG. 20A is a sectional view for illustrating a part of the piezoelectric transducer of the liquid ejection device according to Example 1.

FIG. 20B is a sectional view for illustrating a part of a piezoelectric transducer of a liquid ejection device according to Examples 2 and 3.

### DESCRIPTION OF EMBODIMENTS

When a speed of a liquid droplet to be ejected becomes equal to or higher than a given speed, a minute liquid droplet separate from a main droplet (main liquid droplet) is unintentionally generated before the main droplet. Such a minute liquid droplet as to be generated separately from the main droplet is referred to as “satellite droplet”.

In general, in liquid ejection, the liquid is ejected while a liquid ejection device is being moved relatively to a target on which the liquid droplet is to land. Therefore, after a satellite droplet is generated, the satellite droplet lands in a position different from a landed position of the main droplet. The generation of the satellite droplet causes a pattern failure and the like.

Preferred embodiments of the present invention will now be described in detail in accordance with the accompanying drawings.

### Embodiment

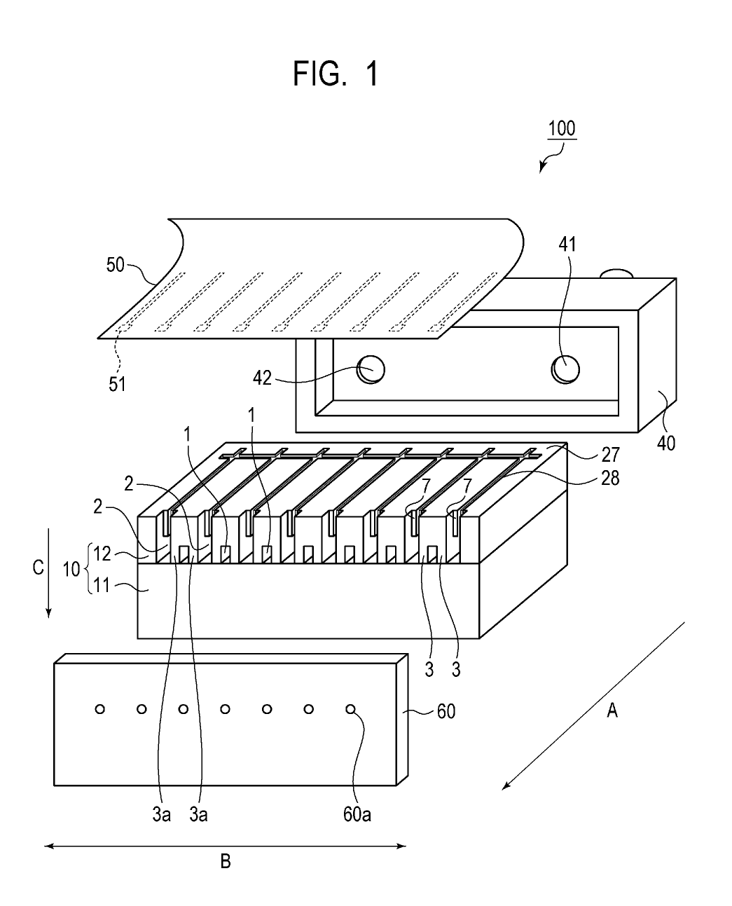

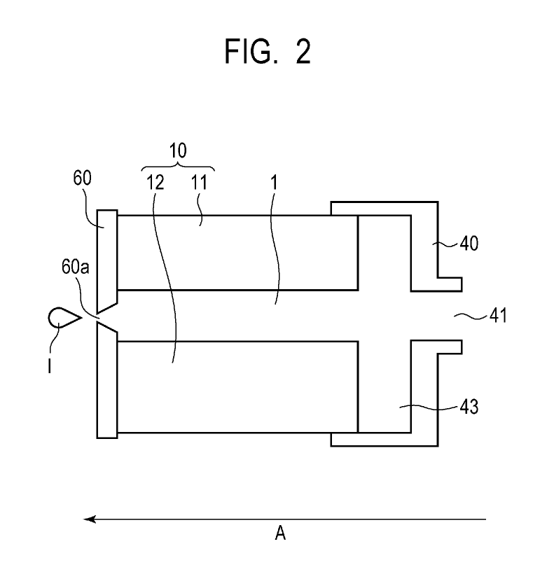

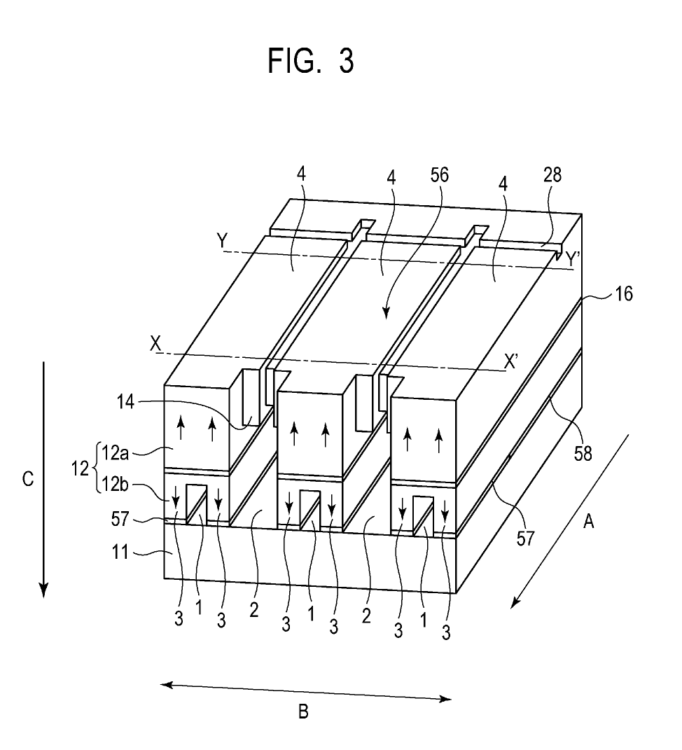

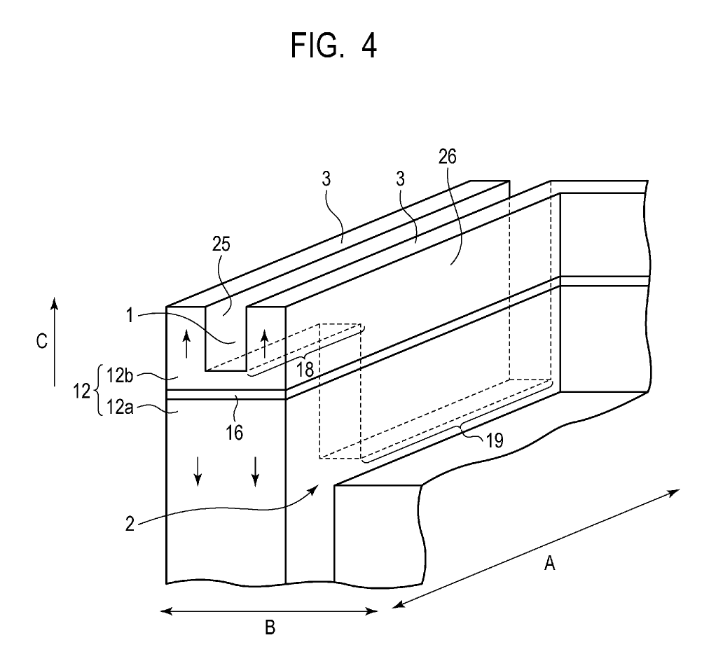

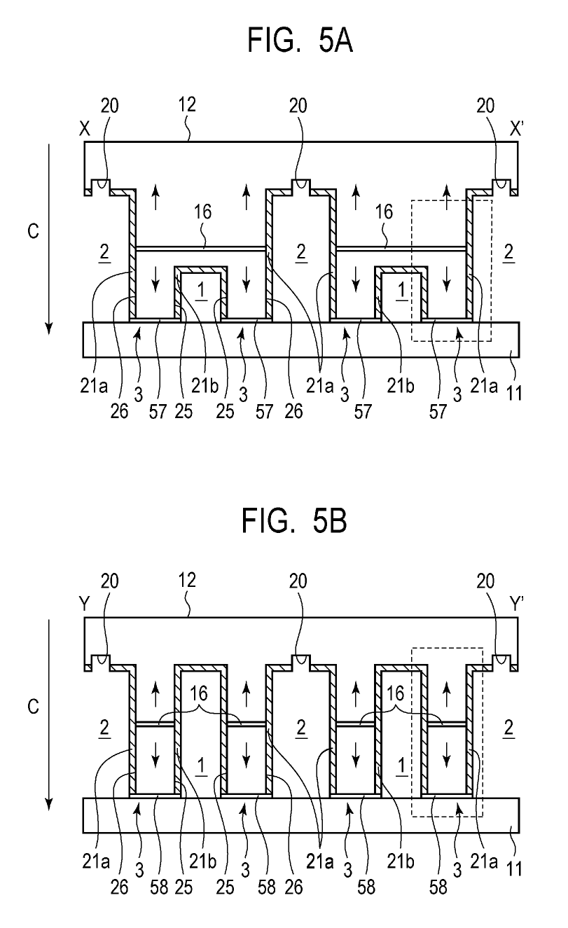

A liquid ejection device according to an embodiment of the present invention is described with reference to the drawings. FIG. 1 is an exploded perspective view for schematically illustrating the liquid ejection device according to this embodiment. FIG. 2 is a sectional view for illustrating a part of a piezoelectric transducer of the liquid ejection device according to this embodiment. FIG. 3 is a perspective view for illustrating a part of the piezoelectric transducer of the liquid ejection device according to this embodiment. FIG. 4 is a perspective view for illustrating a part of the piezoelectric transducer of the liquid ejection device according to this embodiment. FIG. 5A and FIG. 5B are sectional views for illustrating parts of the piezoelectric transducer of the liquid ejection device according to this embodiment. FIG. 5A corresponds to an X-X′ cross section of FIG. 3. FIG. 5B corresponds to a Y-Y′ cross section of FIG. 3.

Note that, a case where a piezoelectric plate 12 is positioned on an upper side and a cover plate 11 is positioned on a lower side is illustrated in FIG. 1, FIG. 3, FIG. 5A, and FIG. 5B, but a vertical relationship between the piezoelectric plate 12 and the cover plate 11 is not limited thereto. The piezoelectric plate 12 may be positioned on the lower side and the cover plate 11 may be positioned on the upper side. In this specification, description is made on the assumption that a surface of the piezoelectric plate 12 on the upper side of the drawing sheets of FIG. 1, FIG. 3, FIG. 5A, and FIG. 5B is a lower surface of the piezoelectric plate 12 and that a surface on the lower side of the drawing sheets of FIG. 1, FIG. 3, FIG. 5A, and FIG. 5B is an upper surface of the piezoelectric plate 12. A direction of the arrow C of FIG. 1, FIG. 3, FIG. 5A, and FIG. 5B is matched with a direction from the lower surface side toward the upper surface side of the piezoelectric plate 12. FIG. 4 is matched with the description of the vertical relationship in this specification.

As illustrated in FIG. 1, a liquid ejection device (inkjet head) 100 according to this embodiment includes a piezoelectric transducer (ejection unit or actuator) 10. The piezoelectric transducer 10 includes the piezoelectric plate (base or substrate main body) and the cover plate (top) 11 mounted to one principal surface (surface on the lower side of FIG. 1) side of the piezoelectric plate 12. In addition, the liquid ejection device 100 according to this embodiment includes an orifice plate (nozzle plate) 60 mounted to a front surface side of the piezoelectric transducer 10 and a manifold 40 arranged on a back surface side of the piezoelectric transducer 10. In addition, the liquid ejection device 100 according to this embodiment includes a flexible substrate 50 for supplying power, which is mounted to one principal surface (surface on the upper side of the drawing sheet of FIG. 1) of the piezoelectric transducer 10.

The piezoelectric plate 12 has a substantially flat plate shape. The piezoelectric plate 12 includes a piezoelectric member 12a and a piezoelectric member 12b fixed on the piezoelectric member 12a. More specifically, as illustrated in FIG. 3, the piezoelectric plate 12 is formed by bonding two piezoelectric bodies (piezoelectric boards or piezoelectric materials) 12a and 12b having opposite polarization directions to each other by use of an adhesive layer 16. Polarization treatment is applied to the piezoelectric member (base-end-side piezoelectric material) 12a in a direction opposite to the direction indicated by the arrow C of FIG. 3. Polarization treatment is applied to the piezoelectric member (distal-end-side piezoelectric material) 12b in the direction indicated by the arrow C of FIG. 3. The piezoelectric plate 12 has a thickness of, for example, about 1 mm.

As a material of the piezoelectric bodies 12a and 12b, for example, piezoelectric ceramics is used. As the piezoelectric ceramics, for example, a lead zirconate titanate (PZT: PbZrₓTi_{1-X}O₃)-based ceramics material, which is a ferroelectric ceramics material, is used. Note that, as the piezoelectric ceramics for forming the piezoelectric bodies 12a and 12b, there may be used, for example, barium titanate (BaTiO₃), or lanthanum-substituted lead zirconate titanate (PLZT: (Pb,La) (Zr,Ti)O₃).

A plurality of grooves (openings) 1 and 2 are formed in the piezoelectric plate 12 so as to be in parallel with one another. A longitudinal direction of the grooves 1 and 2 is matched with a direction indicated by the arrow A of FIG. 1. The groove 1 and the groove 2 are arranged alternately along a direction indicated by the arrow B of FIG. 1. Note that, the direction indicated by the arrow A of FIG. 1 is orthogonal to the direction indicated by the arrow B of FIG. 1. The groove 1 serves to form a pressure chamber (liquid channel). The groove 2 serves to form a dummy pressure chamber, that is, a dummy chamber. The grooves 1 and 2 extend from the front surface side (side to which the orifice plate 60 is mounted) of the piezoelectric transducer 10 to the back surface side (side to which the manifold 40 is mounted) of the piezoelectric transducer 10.

The piezoelectric plate 12 includes partitions (piezoelectric partitions) 3 defined between the groove 1 and the groove 2. Each of the partitions 3 separates pressure chambers 1 and 2 formed in groove shapes from each other. The longitudinal direction of the partition 3 is matched with the arrow A of FIG. 1. A plurality of partitions 3 are arranged at intervals along the direction indicated by the arrow B of FIG. 1. The partitions 3 extend from the front surface side of the piezoelectric transducer 10 to the back surface side of the piezoelectric transducer 10.

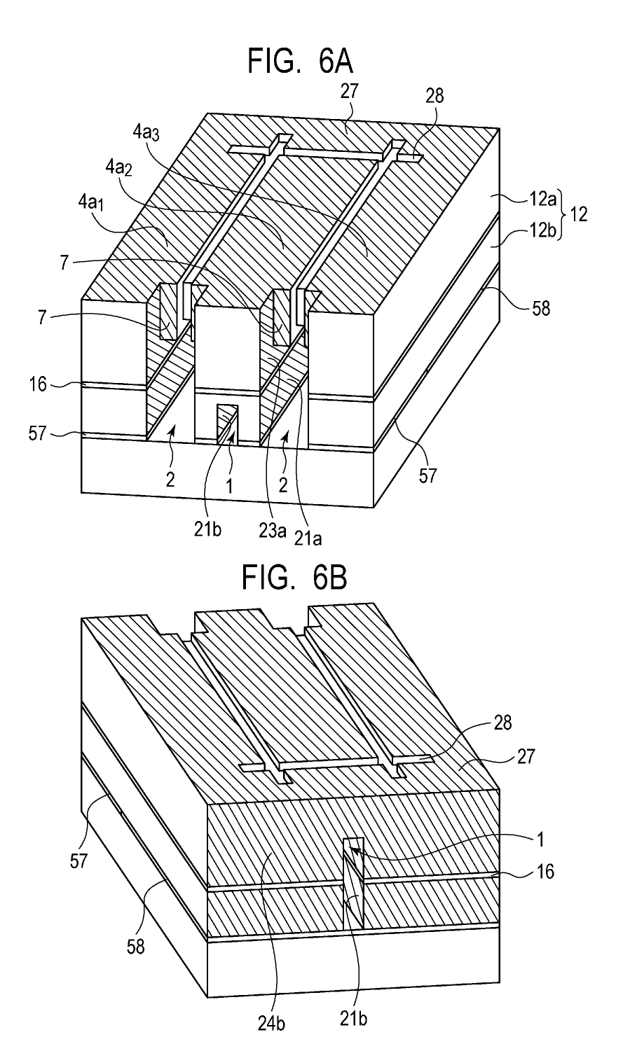

On an end surface of the front surface side of the piezoelectric plate 12, that is, an end surface of the piezoelectric plate 12 on the side to which the orifice plate 60 is mounted, a groove 7 for forming an extracting pattern 23a (see FIG. 6A) extracted from an electrode 21a formed in the groove 2 is formed. The longitudinal direction of the groove 7 is a direction of a normal to the principal surface of the piezoelectric plate 12. The groove 7 is connected to the groove 2 that forms the dummy chamber 2. An end surface of the partition 3 on the front surface side of the piezoelectric plate 12 protrudes relative to a bottom surface 14 (see FIG. 3) of the groove 7.

The cover plate (sometimes referred to simply as “plate”) 11 is mounted to an end surface (here referred to as “principal surface” (surface on the lower side of the drawing sheet of FIG. 1)) of the piezoelectric plate 12 along such a direction as to intersect with the end surface of the partition 3 on the front surface side. Specifically, the cover plate 11 is mounted onto the base. It is preferred to use, as the cover plate 11, for example, a material having a thermal expansion coefficient equivalent to that of the piezoelectric plate 12. Here, as a material of the cover plate 11, the same material as that of the piezoelectric plate 12 is used. One principal surface (end surface along such a direction as to intersect with the end surface of the partition 3 on the front surface side) (surface on the lower side of the drawing sheet of FIG. 1) of the piezoelectric plate 12 and one principal surface (surface on the upper side of the drawing sheet of FIG. 1) of the cover plate 11 are bonded together with adhesive layers 57 and 58 described later. The grooves 1 and 2 are covered with the cover plate 11, and hence pressure chambers are defined as parts in which the grooves 1 and 2 are formed. Note that, the pressure chamber 1 is defined as the part in which the groove 1 is formed, and hence the groove 1 and the pressure chamber 1 share the same reference numeral “1” in descriptions thereof. Further, the pressure chamber (dummy chamber) 2 is defined as the part in which the groove 2 is formed, and hence the groove 2 and the pressure chamber (dummy chamber) 2 share the same reference numeral “2” in descriptions thereof.

The pressure chamber 1 and the pressure chamber 2 adjacent to the pressure chamber 1 are separated from each other by the same partition 3. Therefore, it is not necessarily easy to independently control a capacity of the pressure chamber 1 and a capacity of the pressure chamber 2 adjacent to the pressure chamber 1. Therefore, the pressure chamber 1 is used as a liquid channel, and the pressure chamber 2 adjacent to the pressure chamber 1 is used as a dummy.

The respective capacities of the pressure chambers 1 and 2 can also be controlled so that the pressure chamber 2 can also be used as the liquid channel. For example, an electrode 21b (see FIG. 5A and FIG. 5B) formed to the partition 3 on one side of the pressure chamber 1 and the electrode 21b formed to the partition 3 on the other side of the pressure chamber 1 may be separated from each other, and different signal voltages may be applied to those electrodes 21b. Thus, it is possible to use not only the pressure chamber 1 but also the pressure chamber 2 as the liquid channel.

Here, a case where the pressure chamber 2 is not used as the liquid channel is described as an example.

As illustrated in FIG. 4, in a region 18 on the front surface side of the piezoelectric transducer 10, the pressure chamber 1 is set to be relatively small in depth (the pressure chamber 1 is set to be small in capacity). Specifically, in the region 18 positioned on one side of the pressure chamber 1 in a longitudinal direction A, a bottom of the pressure chamber 1 is positioned in a position shallower than a boundary between the piezoelectric member 12a and the piezoelectric member 12b. Therefore, in the region 18 on the front surface side of the piezoelectric transducer 10, the partition 3 is formed of only the piezoelectric member 12b serving as a first piezoelectric member. In this embodiment, a portion of a partition formed of only the piezoelectric member 12b serving as the first piezoelectric member is referred to as “first partition portion”. Note that, in this specification, for the sake of convenience of description, the same reference numeral “18” is used for the region on the front surface side of the piezoelectric transducer 10, a region of the front surface side of the piezoelectric plate 12, and a region of a front surface side of the cover plate 11.

On the other hand, in a region 19 on the back surface side of the piezoelectric transducer 10, the pressure chamber 1 is set to be relatively large (wide) in depth. Specifically, in the region 19 positioned on the other side of the pressure chamber 1 in the longitudinal direction A, the bottom of the pressure chamber 1 is positioned in a position deeper than the boundary between the piezoelectric member 12a and the piezoelectric member 12b. Therefore, in the region 19 on the back surface side of the piezoelectric plate 12, the partition 3 is formed of the piezoelectric member 12a and the piezoelectric member 12b. Specifically, in the region 19 on the back surface side of the piezoelectric plate 12, the partition 3 has a chevron structure. In this embodiment, a portion of a partition formed of the piezoelectric member 12b serving as the first piezoelectric member and the piezoelectric member 12a serving as a second piezoelectric member is referred to as “second partition portion”. Note that, in this specification, for the sake of convenience of description, the same reference numeral “19” is used for the region on the back surface side of the piezoelectric transducer 10, a region of the back surface side of the piezoelectric plate 12, and a region of a back surface side of the cover plate 11.

As illustrated in FIG. 5A and FIG. 5B, each of the partitions 3 includes a side wall (sometimes referred to also as “side surface”) 25 and a side wall (sometimes referred to also as “side surface”) 26 positioned on a back surface side of the side wall 25. The side wall 25 faces the pressure chamber 1, and the side wall 26 faces the dummy chamber 2. The side wall 25 of one partition 3 and the side wall 25 of another partition 3 adjacent to the one partition 3 are opposed to each other. Further, the side wall 26 of one partition 3 and the side wall 26 of another partition 3 adjacent to the one partition 3 are opposed to each other.

The electrodes (drive electrodes) 21b are formed in the pressure chamber 1. The electrode 21b formed in the pressure chamber 1 is used for applying, in combination with the electrode 21a formed in the dummy chamber 2 to be described later, the partition (piezoelectric member) 3 with an electric field in a direction perpendicular to the polarization direction to displace the partition 3 in a shear mode. The electrodes 21b are formed on the side walls 25 of the partition 3 and a bottom surface of the groove 1. An upper end of the electrode 21b is matched with an upper end of the partition 3. Note that, as described above, for the sake of convenience of description, the description is made here on the assumption that the upper side of the drawing sheets of FIG. 5A and FIG. 5B is the lower side and that the lower side of the drawing sheets of FIG. 5A and FIG. 5B is the upper side.

The electrodes 21a are formed in the dummy chamber 2. The electrodes 21a are formed on the side walls 26 of the partition 3 and a bottom surface of the groove 2. An upper end of the electrode 21a is matched with the upper end of the partition 3.

As illustrated in FIG. 5A, in the first partition portion in the region 18 on the front surface side of the piezoelectric transducer 10, an upper surface (end surface) of the partition 3 is fixed to the cover plate 11 with the first adhesive layer 57. As the adhesive layer 57, an adhesive layer having a relatively low elastic coefficient is used. The elastic coefficient of the adhesive layer 57 is set as a first elastic coefficient.

As illustrated in FIG. 5B, in the second partition portion in the region 19 on the back surface side of the piezoelectric transducer 10, the upper surface (end surface) of the partition 3 is fixed to the cover plate 11 with the second adhesive layer 58. As the adhesive layer 58, an adhesive layer having a relatively high elastic coefficient is used. The elastic coefficient of the adhesive layer 58 is set as a second elastic coefficient higher than the first elastic coefficient (elastic coefficient of the adhesive layer 57).

It is preferred that the elastic coefficient of the first adhesive layer 57 be 10 MPa or more and 500 MPa or less.

It is preferred that the elastic coefficient of the second adhesive layer 58 be 500 MPa or more and 2,000 MPa or less.

The electrode 21a positioned on one side of the dummy chamber 2 and the electrode 21a positioned on the other side of the dummy chamber 2 are separated from each other by a separating groove 20 formed on a bottom surface of the dummy chamber 2. The separating groove is formed along the longitudinal direction (direction indicated by the arrow A) of the dummy chamber 2 so as to extend from one end of the groove 2 and reach the other end of the groove 2. Further, in the groove 7 formed on the front surface side of the piezoelectric plate 12, the separating groove 20 is connected to a separating groove 28 formed on one principal surface (surface on the upper side of the drawing sheet of FIG. 1) of the piezoelectric plate 12 (see FIG. 1). For example, a signal voltage (control voltage or control signal) for applying an electric field having a desired magnitude to the partition 3 is applied to the electrode 21a. The electrode 21a positioned on one side of the dummy chamber 2 and the electrode 21a positioned on the other side of the dummy chamber 2 are electrically separated from each other, and hence it is possible to apply different signal voltages to those electrodes 21a.

The pressure chamber 1 is formed so as to reach the end surface of the piezoelectric plate 12 on the back surface side, that is, the end surface of the piezoelectric plate 12 on the side to which the manifold 40 is mounted (see FIG. 6A and FIG. 6B). With this, liquid is supplied from the manifold 40 into the dummy chamber 2.

On the other hand, the dummy chamber 2 is formed so as not to reach the end surface of the piezoelectric plate 12 on the back surface side, that is, the end surface of the piezoelectric plate 12 on the side to which the manifold 40 is mounted. With this, the liquid is prevented from being supplied from the manifold 40 into the dummy chamber 2.

The manifold 40 is mounted to the back surface side of the piezoelectric transducer 10. A common liquid chamber 43 (see FIG. 2) for supplying liquid (ink) to the pressure chamber 1 of the piezoelectric transducer 10 is formed in the manifold 40. The manifold 40 is constructed such that liquid reserved in a liquid bottle (not shown) is supplied into the manifold 40 through an ink supply port 41 formed on a back surface side of the manifold 40. Further, an ink discharge port (ink collecting port) 42 is also formed on the back surface side of the manifold 40. The ink supply port 41 and the ink discharge port 42 are formed in the manifold 40, which allows the ink to be circulated in the manifold 40.

The orifice plate 60 is mounted on the front surface (surface on a liquid ejecting side) side of the piezoelectric transducer 10. The orifice plate 60 is formed of, for example, plastic. Nozzles (discharge ports) 60a are formed in the orifice plate 60 at positions corresponding to those of the pressure chambers (liquid channels) 1. The nozzles 60a are arrayed in the direction indicated by the arrow B of FIG. 1. The orifice plate 60 is bonded to the end surface of the piezoelectric transducer 10 on the front surface side with, for example, an epoxy-based adhesive (not shown).

As illustrated in FIG. 2, liquid (ink) I supplied from an ink tank (not shown) is supplied to each of the pressure chambers 1 through the ink supply port 41 and the common liquid chamber 43, to be appropriately ejected through each of the nozzles 60a.

As illustrated in FIG. 3, a plurality of extracting electrodes 4 are formed on one principal surface (surface on the upper side of the drawing sheet of FIG. 3) 56 of the piezoelectric plate 12. Those extracting electrodes 4 are formed so as to correspond to the respective pressure chambers 1. The extracting electrode 4 is electrically connected to the electrode 21a or the like through the extracting pattern 23a (see FIG. 6A) or the like. As illustrated in FIG. 1, the flexible substrate 50 is mounted on one surface (surface on the upper side of the drawing sheet of FIG. 1) of the piezoelectric plate 12. A plurality of signal lines (signal electrodes or signal wiring) 51 are formed on the flexible substrate 50. The signal line 51 of the flexible substrate 50 illustrated in FIG. 1 and the extracting electrode 4 illustrated in FIG. 3 are aligned to be connected to each other.

Next, a method of applying a voltage to the each electrode of the liquid ejection device according to this embodiment is described with reference to the drawings. FIG. 6A and FIG. 6B are perspective views for illustrating a part of the piezoelectric transducer of the liquid ejection device according to this embodiment. For brevity of description, the illustrations of FIG. 6A and FIG. 6B include only one pressure chamber 1. FIG. 6A is a perspective view of the piezoelectric transducer 10 when viewed from the front surface side, and FIG. 6B is a perspective view of the piezoelectric transducer 10 when viewed from the back surface side.

As illustrated in FIG. 6A, a plurality of extracting electrodes 4a₁, 4a₂, and 4a₃ and a common electrode 27 are formed on one principal surface (surface on the upper side of the drawing sheets of FIG. 6A and FIG. 6B) of the piezoelectric plate 12.

As illustrated in FIG. 6A, the extracting pattern (extracting electrode) 23a is formed in the groove 7 formed on the front surface side of the piezoelectric plate 12. The extracting pattern 23a formed in the groove 7 is connected to the electrode 21a formed in the dummy chamber 2. Further, the extracting pattern 23a formed in the groove 7 is connected to the extracting electrode 4a₂ formed on one principal surface (surface on the upper side of the drawing sheets of FIG. 6A and FIG. 6B) of the piezoelectric plate 12. Thus, the extracting electrode 4a₂ formed on one principal surface of the piezoelectric plate 12 and the electrode 21a formed in the dummy chamber 2 are electrically connected to each other through the extracting pattern 23a.

As illustrated in FIG. 6B, an extracting pattern (extracting electrode or back electrode) 24b is formed on the back surface side of the piezoelectric plate 12. The extracting pattern 24b formed on the back surface side of the piezoelectric plate 12 is connected to the electrode 21b formed in the pressure chamber 1. Further, the extracting pattern 24b formed on the back surface side of the piezoelectric plate 12 is connected to the common electrode 27 formed on one principal surface (surface on the upper side of the drawing sheets of FIG. 6A and FIG. 6B) of the piezoelectric plate 12. The extracting electrodes 4a₁ and 4a₃ are connected to the common electrode 27. Accordingly, the extracting electrodes 4a₁ and 4a₃ formed on one principal surface of the piezoelectric plate 12 are electrically connected to the electrode 21b formed in the pressure chamber 1 through the common electrode 27 and the extracting pattern 24b.

The extracting electrodes 4a₁, 4a₂, and 4a₃ are electrically connected to the respective signal lines formed on the flexible substrate 50 (FIG. 1). Therefore, the respective signal lines 51 formed on the flexible substrate 50 are electrically connected to the electrode 21a formed in the dummy chamber 2 and the electrode 21b formed in the pressure chamber 1.

Therefore, when a voltage Va is applied to any one of the plurality of signal lines 51 formed on the flexible substrate 50 (FIG. 1), the voltage Va is applied to the electrode 21a within the dummy chamber 2 through the extracting electrode 4a₂ and the extracting pattern 23a.

Further, in the same manner, when a voltage Vb is applied to any one of the plurality of signal lines 51 formed on the flexible substrate 50 (FIG. 1), the voltage Vb is applied to the electrode 21b within the pressure chamber 1 through the extracting electrodes 4a₁ and 4a₃ and the extracting pattern 24b.

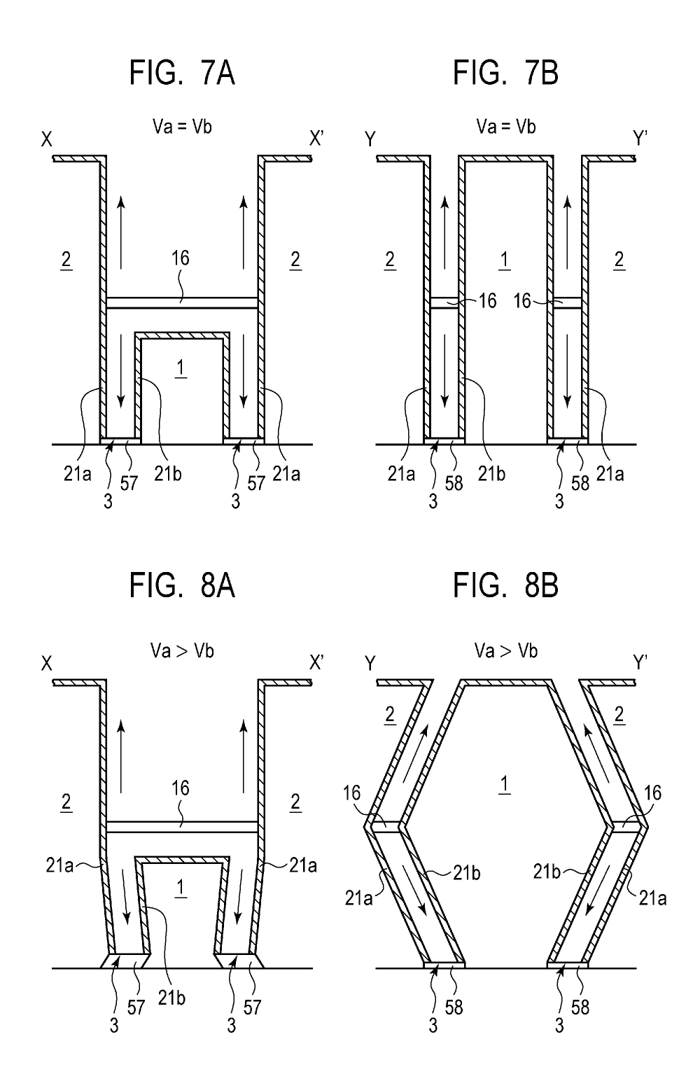

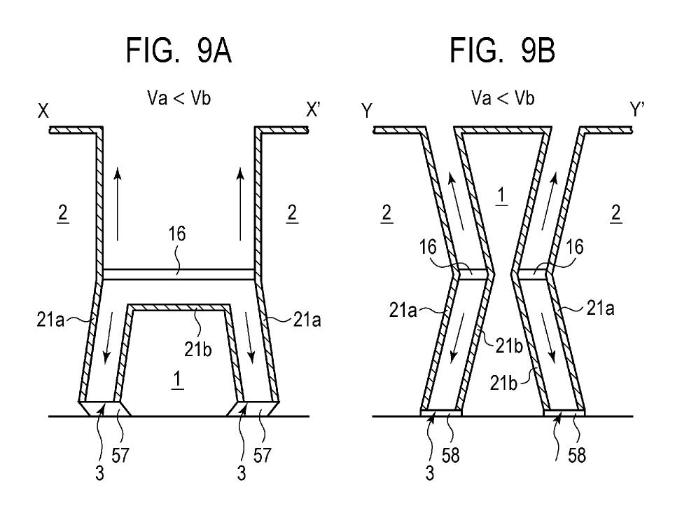

Next, displacement of the partition of the piezoelectric transducer of the liquid ejection device according to this embodiment is described with reference to FIG. 7A to FIG. 9B. FIG. 7A to FIG. 9B are sectional views for illustrating the displacement of the partition of the piezoelectric transducer of the liquid ejection device according to this embodiment. Note that, the description is made here on the assumption that the electrode 21a within the dummy chamber 2 has a potential Va and that the electrode 21b within the pressure chamber 1 has a potential Vb. FIG. 7A, FIG. 8A, and FIG. 9A each correspond to an X-X′ cross section of FIG. 3. Specifically, FIG. 7A, FIG. 8A, and FIG. 9A are views for each illustrating a cross section of the region 18 on the front surface side of the piezoelectric transducer 10. FIG. 7B, FIG. 8B, and FIG. 9B each correspond to a Y-Y′ cross section of FIG. 3. Specifically, FIG. 7B, FIG. 8B, and FIG. 9B are views for each illustrating a cross section of the region 19 on the back surface side of the piezoelectric transducer 10.

A case where the potential Va of the electrode 21a within the dummy chamber 2 is equal to the potential Vb of the electrode 21b within the pressure chamber 1, that is, a case where Va=Vb, is illustrated in FIG. 7A and FIG. 7B. In this case, as can be seen from FIG. 7A, in the region 18 on the front surface side of the piezoelectric transducer 10, the partition 3 is not displaced. Further, as can be seen from FIG. 7B, in the region 19 on the back surface side of the piezoelectric plate 12, the partition 3 is not displaced as well.

A case where the potential Va of the electrode 21a within the dummy chamber 2 is higher than the potential Vb of the electrode 21b within the pressure chamber 1, that is, a case where Va>Vb, is illustrated in FIG. 8A and FIG. 8B. The potential Va of the electrode 21a within the dummy chamber 2 is higher than the potential of the electrode 21b within the pressure chamber 1, and hence an electric field is applied in a direction orthogonal to the polarization direction.

As illustrated in FIG. 8A, in the region 18 on the front surface side of the piezoelectric transducer 10, the partition 3 is fixed to the cover plate 11 with the adhesive layer 57 having a relatively low elastic coefficient. The elastic coefficient of the adhesive layer 57 is relatively low, and hence the adhesive layer 57 is likely to deform so as to follow the displacement of the partition 3. Therefore, in the region 18 on the front surface side of the piezoelectric transducer 10, even though the electrodes 21a and 21b cover all the side walls 25 and 26 of the partition 3, the partition 3 can be sufficiently displaced. In the region 18 on the front surface side of the piezoelectric transducer 10, the partition 3 is displaced so that a cross sectional area of the pressure chamber 1 decreases.

As illustrated in FIG. 8B, in the region 19 on the back surface side of the piezoelectric transducer 10, the partition 3 is fixed to the cover plate 11 with the adhesive layer 58 having a relatively high elastic coefficient. The elastic coefficient of the adhesive layer 58 is relatively high, and hence the partition 3 is fixed to the cover plate 11 with reliability. Note that, in the region 19 on the back surface side of the piezoelectric transducer 10, the partition 3 is fixed to the cover plate 11 with reliability by use of the adhesive layer 58 having a relatively high elastic coefficient in order to sufficiently ensure control property for the capacity of the pressure chamber 1. In the region 19 on the back surface side of the piezoelectric transducer 10, the partition 3 is displaced so that the cross sectional area of the pressure chamber 1 increases.

A case where the potential Va of the electrode 21a within the dummy chamber 2 is lower than the potential Vb of the electrode 21b within the pressure chamber 1, that is, a case where Va<Vb, is illustrated in FIG. 9A and FIG. 9B. The potential Va of the electrode 21a within the dummy chamber 2 is lower than the potential of the electrode 21b within the pressure chamber 1, and hence, in the case of FIG. 9A and FIG. 9B, an electric field is applied in a direction opposite to the direction of the electric field in the case of FIG. 8A and FIG. 8B.

In the region 18 on the front surface side of the piezoelectric transducer 10, as illustrated in FIG. 9A, the partition 3 is displaced so that the cross sectional area of the pressure chamber 1 increases.

In the region 19 on the back surface side of the piezoelectric transducer 10, as illustrated in FIG. 9B, the partition 3 is displaced so that the cross sectional area of the pressure chamber 1 decreases.

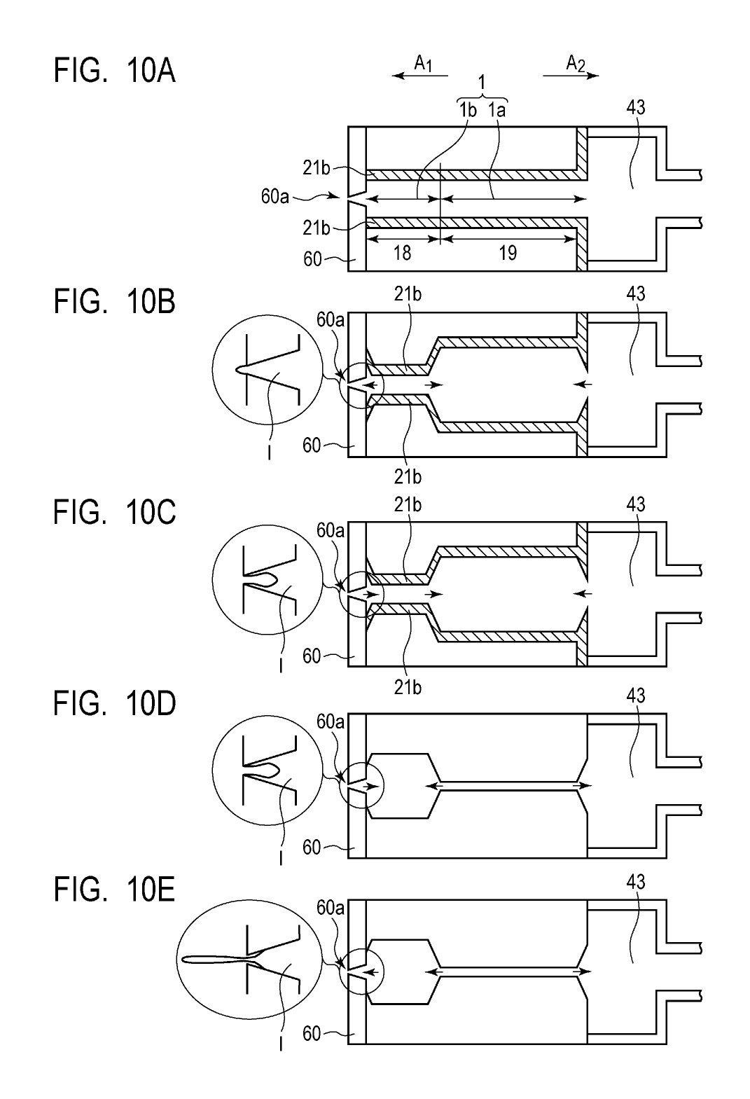

Next, an operation of the liquid ejection device according to this embodiment is described with reference to FIG. 10A to FIG. 10E. FIG. 10A to FIG. 10E are sectional views for illustrating the operation of the piezoelectric transducer of the liquid ejection device according to this embodiment. Here, the description is made on the assumption that a part of the pressure chamber 1 that is positioned in the region on the front surface side of the piezoelectric transducer 10 is a partial pressure chamber 1b. Further, the description is made here on the assumption that a part of the pressure chamber 1 that is positioned in the region 19 on the back surface side of the piezoelectric transducer 10 is a partial pressure chamber 1a.

A case where the potential Va of the electrode 21a within the dummy chamber 2 is equal to the potential Vb of the electrode 21b within the pressure chamber 1, that is, a case where Va=Vb, is illustrated in FIG. 10A. Specifically, a state illustrated in FIG. 10A corresponds to the state described above with reference to FIG. 7A and FIG. 7B. In the state illustrated in FIG. 10A, the ink I within the pressure chamber 1 does not flow.

FIG. 10B is an illustration of a state immediately after the voltage is applied so that the potential Va of the electrode 21a within the dummy chamber 2 becomes higher than the potential Vb of the electrode 21b within the pressure chamber 1, that is, a state immediately after the voltage is applied so as to satisfy Va>Vb. The state illustrated in FIG. 10B corresponds to the state described above with reference to FIG. 8A and FIG. 8B. In the region 18 on the front surface side of the piezoelectric transducer 10, the partition 3 is displaced in such a direction as to contract the pressure chamber 1 (FIG. 8A). Specifically, the partition 3 is displaced in such a direction as to contract the partial pressure chamber 1b. On the other hand, in the region 19 on the back surface side of the piezoelectric transducer 10, the partition 3 is displaced in such a direction as to expand the pressure chamber 1 (FIG. 8B). Specifically, the partition 3 is displaced in such a direction as to expand the partial pressure chamber 1a. When the partition 3 is thus displaced, the ink I flows into the partial pressure chamber 1a positioned in the region 19 on the back surface side of the piezoelectric transducer 10. On the other hand, in the partial pressure chamber 1b positioned in the region 18 on the front surface side of the piezoelectric transducer 10, the ink I in the vicinity of the nozzle 60a flows in an ejection direction A₁.

FIG. 10C is an illustration of a state after a fixed time has elapsed since the voltage is applied so as to satisfy Va>Vb. In this case, in the partial pressure chamber 1b positioned in the region 18 on the front surface side of the piezoelectric transducer 10, the direction in which the ink I in the vicinity of the nozzle 60a flows is reversed. Specifically, in FIG. 10B, the ink I in the vicinity of the nozzle 60a flows in the ejection direction A₁, while in FIG. 10C, the ink I in the vicinity of the nozzle 60a flows toward a direction A₂ opposite to the ejection direction A₁. It is also conceivable that the flow of the ink I in the vicinity of the nozzle 60a is reversed in this way for the following reason. Specifically, a displacement amount of the partition 3 in the region 19 on the back surface side of the piezoelectric transducer 10 is larger than a displacement amount of the partition 3 in the region 18 on the front surface side of the piezoelectric transducer 10. Therefore, a change amount in the capacity of the partial pressure chamber 1a positioned in the region 19 on the back surface side of the piezoelectric transducer 10 becomes larger than a change amount in the capacity of the partial pressure chamber 1b positioned in the region 18 on the front surface side of the piezoelectric transducer 10. It is conceivable that the flow of the ink I drawn into the partial pressure chamber 1b becomes therefore dominant, and hence the flow of the ink I in the vicinity of the nozzle 60a is reversed.

FIG. 10D is an illustration of a state immediately after the voltage is applied so that the potential Va of the electrode 21a within the dummy chamber 2 becomes lower than the potential Vb of the electrode 21b within the pressure chamber 1, that is, a state immediately after the voltage is applied so as to satisfy Va<Vb. The state illustrated in FIG. 10D corresponds to the state described above with reference to FIG. 9A and FIG. 9B. In the region 18 on the front surface side of the piezoelectric transducer 10, the partition 3 is displaced in such a direction as to expand the pressure chamber 1 (FIG. 9A). Specifically, the partition 3 is displaced in such a direction as to expand the partial pressure chamber 1b. On the other hand, in the region 19 on the back surface side of the piezoelectric transducer 10, the partition 3 is displaced in such a direction as to contract the pressure chamber 1 (FIG. 9B). Specifically, the partition 3 is displaced in such a direction as to contract the partial pressure chamber 1a. When the partition 3 is thus displaced, the ink I flows out of the partial pressure chamber 1a positioned in the region 19 on the back surface side of the piezoelectric transducer 10. On the other hand, in the partial pressure chamber 1b positioned in the region 18 on the front surface side of the piezoelectric transducer 10, the ink I in the vicinity of the nozzle 60a flows in the direction A₂ opposite to the ejection direction A₁.

FIG. 10E is an illustration of a state after a fixed time has elapsed since the voltage is applied so as to satisfy Va<Vb. In this case, in the partial pressure chamber 1b positioned in the region 18 on the front surface side of the piezoelectric transducer 10, the flow of the ink I in the vicinity of the nozzle 60a is reversed. Specifically, in FIG. 10D, the ink I in the vicinity of the nozzle 60a flows in the direction A₂ opposite to the ejection direction A₁, while in FIG. 10E, the ink I in the vicinity of the nozzle 60a flows toward the ejection direction A₁.

In this embodiment, in the case of FIG. 10D, the ink I in the vicinity of the nozzle 60a flows in the direction A₂ opposite to the ejection direction A₁. The flow of the ink I in the opposite direction A₂ plays a role in alleviating the flow of the ink I flowing in the ejection direction A₁ in the case of FIG. 10E. Therefore, according to this embodiment, sudden concentration of ink into the nozzle 60a can be alleviated, and a liquid droplet (satellite droplet) separate from a main droplet (main liquid droplet) of the ink can be inhibited from being formed before the main droplet. Therefore, according to this embodiment, it is possible to provide a liquid ejection device capable of ejecting liquid with stability.

Further, it is possible to eject liquid with stability at a desired ejection speed by appropriately setting the displacement amount of the partition 3 in the region 18 on the front surface side of the piezoelectric transducer 10 and the displacement amount of the partition 3 in the region 19 on the back surface side of the piezoelectric transducer 10.

In this way, according to this embodiment, in the region 19 on the back surface side of the piezoelectric transducer 10, the bottom surface of the pressure chamber 1 is positioned in the position deeper than the boundary between the piezoelectric member 12a and the piezoelectric member 12b. On the other hand, in the region 18 on the front surface side of the piezoelectric transducer 10, the bottom surface of the pressure chamber 1 is positioned in the position shallower than the boundary between the piezoelectric member 12a and the piezoelectric member 12b. Further, on the front surface side of the piezoelectric transducer 10, the upper surface of the partition 3 is fixed to the cover plate 11 with the adhesive layer 57 having a relatively low elastic coefficient. Therefore, according to this embodiment, in the region 18 on the front surface side of the piezoelectric transducer 10, the partition 3 can be displaced with reliability. Accordingly, when the pressure chamber is contracted in the region 19 on the back surface side of the piezoelectric transducer 10, the pressure chamber can be expanded in the region on the front surface side of the piezoelectric transducer. Therefore, according to this embodiment, when the liquid droplet is ejected by contracting the region 19 on the back surface side of the piezoelectric transducer 10, it is possible to alleviate the sudden concentration of pressure into a nozzle, which can inhibit a satellite droplet from being generated. Accordingly, according to this embodiment, it is possible to provide a liquid ejection device capable of ejecting a minute liquid droplet with stability.

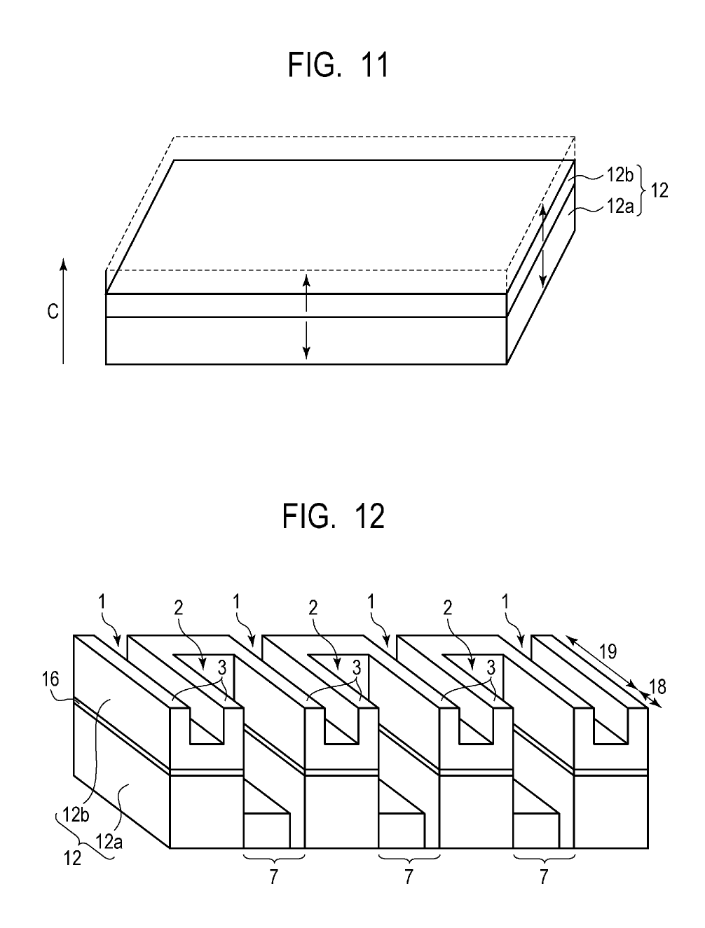

Next, a method of manufacturing a liquid ejection device according to this embodiment is described with reference to FIG. 11 to FIG. 16. FIG. 11 to FIG. 16 are process views for illustrating the method of manufacturing a liquid ejection device according to this embodiment.

First, two piezoelectric substrates (piezoelectric bodies) 12a and 12b having opposite polarization directions are bonded together by use of the adhesive layer 16 (see FIG. 3). The polarization treatment is applied to the piezoelectric member (base-end-side piezoelectric material) 12a in the direction opposite to the direction indicated by the arrow C of FIG. 11. The polarization treatment is applied to the piezoelectric member (distal-end-side piezoelectric material) 12b in the direction indicated by the arrow C of FIG. 11. As the material of the piezoelectric bodies 12a and 12b, for example, PZT, barium titanate, or PLZT is used. Here, for example, PZT is used as the material of the piezoelectric bodies 12a and 12b.

Subsequently, a surface of the piezoelectric member 12b is subjected to cutting (grinding) so that the thickness of the piezoelectric member 12b becomes a desired thickness. In this way, the piezoelectric plate 12 in which the piezoelectric member 12b having a desired thickness is arranged on the piezoelectric member 12a is obtained (see FIG. 11). Note that, the broken line of FIG. 11 is an illustration of a state before the piezoelectric member 12b is subjected to the grinding.

Subsequently, as illustrated in FIG. 12, the grooves 1 for forming the pressure chambers are formed in the piezoelectric plate 12 by use of, for example, a diamond blade (not shown). That is, the grooves are formed to form the pressure chambers separated by the partitions having the first partition portion obtained by cutting up to the first piezoelectric member and the second partition portion obtained by cutting from the first piezoelectric member up to the second piezoelectric member.

Specifically, the plurality of grooves 1 are formed so as to be in parallel with one another. In the forming of the grooves 1, only the piezoelectric member 12b is processed in the region 18 on the front surface side (front side of the drawing sheet of FIG. 12) of the piezoelectric plate 12, more specifically, in the region in the vicinity of the end surface of the piezoelectric plate 12 on the front surface side. On the other hand, both the piezoelectric member 12a and the piezoelectric member 12b are processed in the region 19 on the back surface side of the piezoelectric plate 12. In the region 18 on the front surface side of the piezoelectric plate 12, the processing is performed so that the grooves 1 become shallow. On the other hand, in the region 19 on the back surface side of the piezoelectric plate 12, the processing is performed so that the grooves 1 become deep. It is preferred to use, as a dicing apparatus, a dicing apparatus that can be at least biaxially controlled. In this case, as the dicing apparatus, for example, a dicing saw manufactured by DISCO Corporation (trade name: Fully Automatic Dicing Saw, model No: DAD6240, spindle type: 1.2 kW) is used. It is preferred not to set a feeding speed of a stage that supports the piezoelectric plate 12 to be excessively high, in order to prevent the piezoelectric plate 12 from being excessively stressed when being processed by use of the diamond blade. Note that, some of a large number of grooves 1 to be formed are extracted in the illustration of FIG. 12.

Then, the grooves 2 for forming the dummy chambers are formed in the piezoelectric plate 12 by use of the diamond blade (not shown). As a dicing apparatus, for example, a dicing apparatus similar to the dicing apparatus used in forming the grooves 1 can be used. The grooves 2 are formed so as to be along the longitudinal direction of the grooves 1. The plurality of grooves 2 are formed so as to be in parallel with one another. Regions in which the grooves 2 are to be formed are set so that the plurality of grooves 2 are at the centers between the plurality of grooves 1 formed so as to be in parallel with one another, respectively. The grooves 2 are formed so as not to reach the end surface of the piezoelectric plate 12 on the back surface side. This is for the purpose of preventing liquid from being supplied from the manifold 40 into the dummy chambers 2. In the region 19 on the back surface side of the piezoelectric plate 12, the depth of the grooves 2 is, for example, the same as that of the grooves 1. Note that, the depth of the grooves 2 is not required to be the same as that of the grooves 1. For example, the depth of the grooves 2 may be appropriately set in a range of from 1 to 1.15 times as much as the depth of the grooves 1. A portion between the groove 1 and the groove 2 serves as the partition 3. The partition 3 is positioned on both sides of the pressure chamber formed by the groove 1.

Then, the grooves 7 are formed in the end surface of the piezoelectric plate 12 on the front surface side by use of the diamond blade (not shown). The grooves 7 are formed so as to extend in the direction of the normal to the principal surface of the piezoelectric plate 12. The grooves 7 are formed for the purpose of forming the extracting patterns 23a extracted from the electrodes 21a. Processing conditions in forming the grooves 7 are, for example, similar to processing conditions in forming the grooves 2. The grooves 7 are formed on the front surface side of the piezoelectric plate 12, that is, on the front side of the drawing sheet of FIG. 12, so as to communicate to the grooves 2.

Note that, the case of the processing using the diamond blade is described here as an example, but the present invention is not limited thereto. A processing tool capable of performing the processing so as to keep the piezoelectric plate 12 below a Curie temperature can be appropriately used. For example, the piezoelectric plate 12 may be processed by use of an end mill or the like.

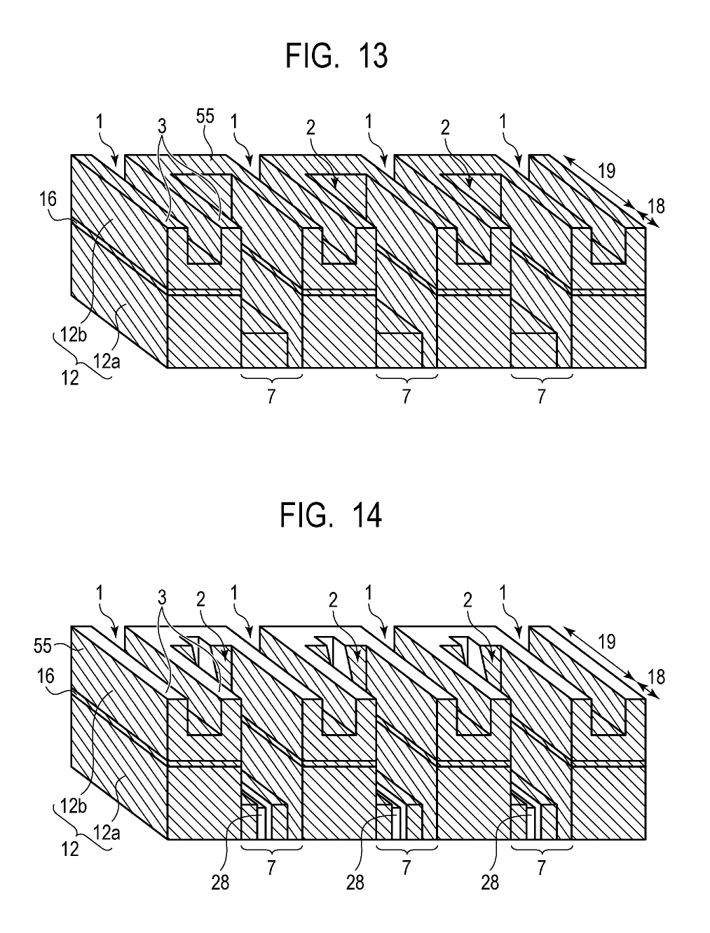

Then, as illustrated in FIG. 13, a conductive film 55 serving as an electrode covering an entire surface of the piezoelectric plate 12 is formed. The conductive film 55 can be formed as described below.

First, by etching the surface of the piezoelectric plate 12, minute depressions (unevenness) are formed in the surface of the piezoelectric plate 12. Then, deleading treatment for removing from the surface of the piezoelectric plate 12 lead (Pb) contained in the material of the piezoelectric plate 12 is applied.

Next, as described below, a plated catalyst is deposited onto the surface of the piezoelectric plate 12. For example, tin (Sn) and palladium (Pd) are used as the plated catalyst. In this case, the deposition is described by way of the case where the plated catalyst of palladium is generated. First, the piezoelectric plate 12 is immersed into an aqueous solution of stannous chloride with a concentration of about 0.1%, thereby depositing stannous chloride onto the surface of the piezoelectric plate 12. Subsequently, the piezoelectric plate 12 is immersed into an aqueous solution of palladium chloride with a concentration of about 0.1%, thereby allowing an oxidation-reduction reaction between tin chloride, which is deposited onto the piezoelectric plate 12 in advance, and palladium chloride to occur to generate metallic palladium on the surface of the piezoelectric plate 12. Thus, the plated catalyst of metallic palladium is deposited onto the surface of the piezoelectric plate 12.

Next, the piezoelectric plate 12 in which metallic palladium is generated on its surface is immersed into, for example, a nickel plating bath, thereby forming an electroless plating film containing nickel (Ni) on the surface of the piezoelectric plate 12. For example, the following films are formed as the electroless plating film: an electroless plating film of nickel-phosphorus (Ni—P) and an electroless plating film of nickel-boron (Ni—B). It is preferred that a thickness of the electroless plating film be set to be about 0.5 μm to 1.0 μm for the purpose of sufficiently cover the surface of the piezoelectric plate 12 and sufficiently reducing electrical resistance. In this way, the electroless plating film is formed on the entire surface of the piezoelectric plate 12.

After that, for example, through replacement plating, a gold (Au) plating film, for example, is formed on the electroless plating film. In this way, the conductive film 55 including the plating film is formed on the entire surface of the piezoelectric plate 12.

Then, unnecessary portions of the conductive film formed on the entire surface of the piezoelectric plate 12 are removed (see FIG. 14). The unnecessary portions of the conductive film 55 can be removed as described below.

Portions of the conductive film 55 on one principal surface (surface on the upper side of the drawing sheet of FIG. 14) and on the other principal surface (surface on the lower side of the drawing sheet of FIG. 14) of the piezoelectric plate 12 are removed. The portions of the conductive film 55 on one principal surface and on the other principal surface of the piezoelectric plate 12 can be removed by, for example, polishing.

Further, the separating groove 20 is formed at the bottom of the groove 2 to serve as the dummy chamber, and the separating groove 28 is formed at the bottom of the groove 7 for the extracting electrode. The separating grooves 20 and 28 are for the purpose of separating the electrode 21a positioned on one side of the grooves 2 and 7 and the electrode 21a positioned on the other side of the grooves 2 and 7 from each other. When the separating grooves 20 and 28 are formed, for example, the diamond blade can be used. The separating grooves 20 and 28 each have a width of, for example, about ½ to ⅓ of the width of the groove 2 or 7. Note that, the width of the separating grooves 20 and 28 is not limited thereto, and may be appropriately set. The separating groove 20 is formed along the longitudinal direction of the groove 2 so as to extend from a front end of the groove 2 to reach a rear end thereof. Further, the separating groove 28 is formed along the longitudinal direction of the groove 7 so as to extend from an upper end of the groove 7 to reach a lower end thereof. The electrode 21a positioned on one side of the groove 2 or 7 and the electrode 21a positioned on the other side of the groove 2 or 7 are separated from each other, and thus, different signal voltages can be applied to those electrodes 21a. Therefore, the partitions 3 of the pressure chambers 1 can be individually displaced.

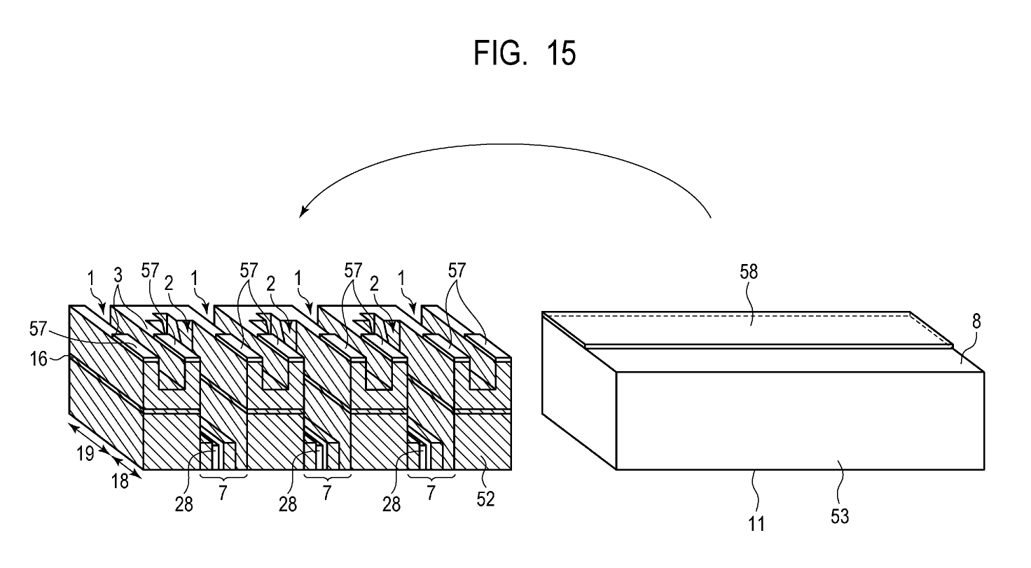

Then, as illustrated in FIG. 15, the cover plate (top) 11 is mounted onto the piezoelectric plate 12. It is preferred to use, as a material of the cover plate 11, for example, a material having a thermal expansion coefficient equivalent to that of the piezoelectric plate 12. In this case, as the material of the cover plate 11, the same material as that of the piezoelectric plate 12 is used. In this case, as the material of the cover plate 11, for example, PZT is used. Note that, the material of the cover plate 11 is not limited to the same material as that of the piezoelectric plate 12. As the material of the cover plate 11, a ceramics material such as alumina may also be used. In the region 18 on the front surface side of the piezoelectric plate 12 (first partition portion), the end surface (one principal surface (surface on the upper side of the drawing sheet of FIG. 15)) of the piezoelectric plate 12 and one principal surface (surface on the upper side of the drawing sheet of FIG. 15) of the cover plate 11 are bonded together with, for example, the adhesive layer 57 having a relatively low elastic coefficient. As the adhesive layer 57, for example, a first adhesive having a solidification-time elastic coefficient of 10 MPa or more and 500 MPa or less is applied on the piezoelectric plate 12 side. More specifically, the adhesive layer 57 is applied on the upper surface of the partition 3. In the region 19 on the back surface side of the piezoelectric plate 12 (second partition portion), the end surface (one principal surface (surface on the upper side of the drawing sheet of FIG. 15)) of the piezoelectric plate 12 and one principal surface (surface on the upper side of the drawing sheet of FIG. 15) of the cover plate 11 are bonded together with, for example, the adhesive layer 58 having a relatively high elastic coefficient. As the adhesive layer 58, for example, a second adhesive having a solidification-time elastic coefficient of 500 MPa or more and 2,000 MPa or less is applied on the cover plate 11. Then, the piezoelectric plate 12 and the cover plate 11 are aligned to be joined to each other. The grooves 1 and 2 are sealed by the cover plate 11, and hence the pressure chambers 1 and 2 are formed along the longitudinal direction of the grooves 1 and 2. In other words, the first partition portion and the plate are bonded together with the first adhesive, and the second partition portion and the plate are bonded together with the second adhesive.

Note that, the case where the adhesive layer 57 is applied on the piezoelectric plate 12 side and the adhesive layer 58 is applied on the cover plate 11 side is described here as an example, but the present invention is not limited thereto. The adhesive layer 57 may be applied on the cover plate 11 side, and the adhesive layer 58 may be applied on the piezoelectric plate 12 side.

The adhesive layers 57 and 58 can be directly applied on the piezoelectric plate 12 and the cover plate 11 by, for example, a screen printing method, a bar coating method, or an offset printing method. Further, after the adhesive layers 57 and 58 are applied on different substrates such as glass substrates by use of at least of one of those application methods, the adhesive layers 57 and 58 applied on the different substrates may be transferred onto the piezoelectric plate 12 and the cover plate 11.

Subsequently, the front surface side, the back surface side, and the like of the piezoelectric plate 12 are subjected to grinding, polishing, and the like, to thereby remove the conductive film 55 from the piezoelectric plate 12 and adjust the external shape and dimensions.

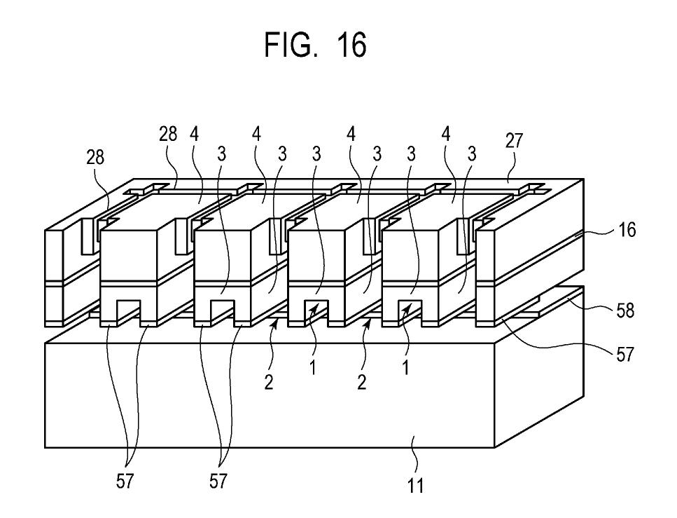

Subsequently, the separating groove (not shown) is appropriately formed in one principal surface (surface on the upper side of the drawing sheet of FIG. 16) of the piezoelectric plate 12. The separating groove 28 is formed for the purpose of separating the extracting electrodes 4 from one another. The separating groove 28 can be formed by, for example, scanning with a laser beam. As the laser beam, for example, an excimer laser or a KrF laser is used. Note that, the separating groove 28 can be formed by processing using the diamond blade or the like.

After that, the manifold 40 is mounted on the back surface side of the piezoelectric transducer 10 (see FIG. 1). The manifold 40 has the common liquid chamber 43 (see FIG. 2) formed therein for supplying liquid to the pressure chambers 1 in the piezoelectric transducer 10. Liquid stored in a liquid bottle (not shown) is supplied into the manifold 40 through the ink supply port 41 formed on the back surface side of the manifold 40. Further, the ink discharge port 42 is also formed in the manifold 40. The ink supply port 41 and the ink discharge port 42 are formed in the manifold 40, which allows the ink to be circulated in the manifold 40.

Further, the orifice plate 60 is mounted on the front surface side of the piezoelectric plate 12 (see FIG. 1). The orifice plate 60 can be formed as described below. First, a plate-like substance for forming the orifice plate 60 is prepared. As a material of such a plate-like substance, for example, plastic is used. In this case, as the material of the plate-like substance, for example, a polyimide is used. Then, an ink-repellent film (not shown) is formed on a first principal surface that is one principal surface of the plate-like substance. The first principal surface of the plate-like substance is the principal surface that is opposite to a principal surface (second principal surface) that is opposed to the piezoelectric plate 12 when the orifice plate 60 is mounted to the piezoelectric plate 12. As a material of the ink-repellent film, for example, an amorphous fluorine resin manufactured by ASAHI GLASS CO., LTD. (trade name: CYTOP) is used. Then, a laser beam is radiated to the plate-like substance to form holes in the plate-like substance, to thereby form the nozzles 60a. When the holes are formed in the plate-like substance, the laser beam is radiated in a direction from the second principal surface side to the first principal surface side of the plate-like substance. As the laser beam, for example, an excimer laser is used. The holes formed in the plate-like substance become smaller from the second principal surface side toward the first principal surface side of the plate-like substance. The nozzles 60a are formed at positions corresponding to those of the pressure chambers (liquid channels) 1, respectively. In this way, the orifice plate 60 having the nozzles 60a formed therein is obtained. The orifice plate 60 is bonded to the end surface (bonded surface) of the piezoelectric plate 12 on the front surface side using, for example, an epoxy-based adhesive (not shown).

Further, the flexible substrate 50 is mounted to one principal surface (surface on the upper side of the drawing sheet of FIG. 1) of the piezoelectric plate 12 (see FIG. 1). The plurality of signal lines 51 are formed on the flexible substrate 50. The flexible substrate 50 and the piezoelectric plate 12 are aligned, and the flexible substrate 50 and the piezoelectric plate 12 are bonded together by thermocompression bonding, for example.

In this way, the liquid ejection device according to this embodiment is manufactured.

### Modification Example

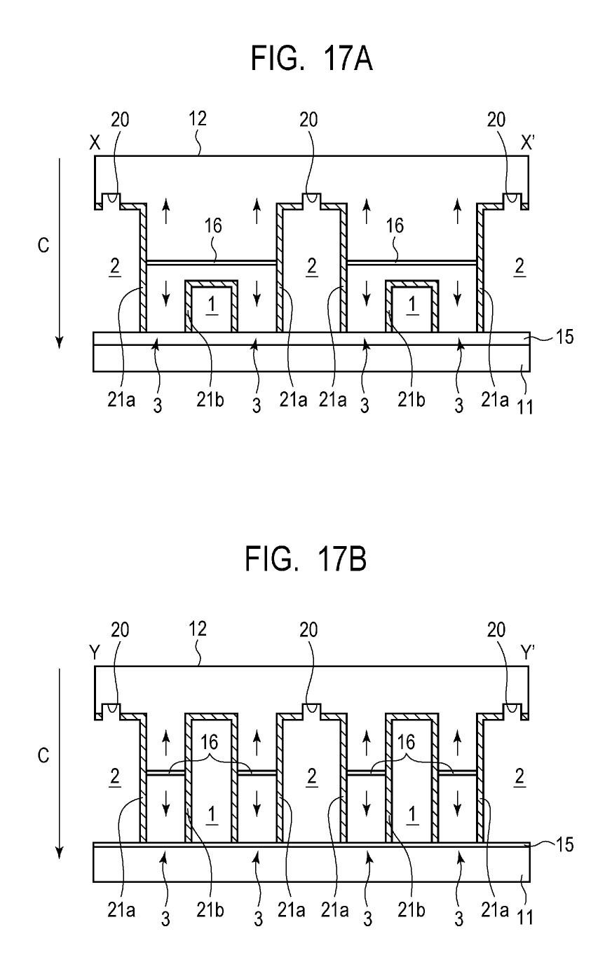

Next, a liquid ejection device according to a modification example of this embodiment is described with reference to FIG. 17A and FIG. 17B. FIG. 17A and FIG. 17B are sectional views for illustrating parts of a piezoelectric transducer of the liquid ejection device according to this modification example. FIG. 17A corresponds to an X-X′ cross section of FIG. 3. Specifically, FIG. 17A is a view for illustrating a cross section of the region 18 on the front surface side of the piezoelectric transducer 10. FIG. 17B corresponds to a Y-Y′ cross section of FIG. 3. Specifically, FIG. 17B is a view for illustrating a cross section of the region 19 on the back surface side of the piezoelectric transducer 10.

As illustrated in FIG. 17A and FIG. 17B, the liquid ejection device according to this modification example has an adhesive layer 15 formed to be relatively thick in the region 18 on the front surface side of the piezoelectric transducer 10, and has the adhesive layer 15 to be relatively thin in the region on the back surface side of the piezoelectric transducer 10.

In this modification example, in the region 18 on the front surface side of the piezoelectric transducer 10, the adhesive layer 15 is formed to be relatively thick, and hence the adhesive layer 15 is likely to deform so as to follow the displacement of the partition 3. Therefore, in the region 18 on the front surface side of the piezoelectric transducer 10, even though the electrodes 21a and 21b cover all the side walls 25 and 26 of the partition 3, the partition 3 can be sufficiently displaced.

In this way, in the region 18 on the front surface side of the piezoelectric transducer 10, the adhesive layer 15 may also be formed to be relatively thick.

Next, an operation of the liquid ejection device according to this modification example is described.

In the case where the potential Va of the electrode 21a within the dummy chamber 2 is equal to the potential Vb of the electrode 21b within the pressure chamber 1, that is, in the case where Va=Vb, the liquid ejection device according to this modification example also conducts the same operation as the operation of the liquid ejection device according to the embodiment described above with reference to FIG. 7A and FIG. 7B. Specifically, the partition 3 does not deform in the region 18 on the front surface side of the piezoelectric transducer 10. Further, the partition 3 does not deform in the region 19 on the back surface side of the piezoelectric plate 12 as well.

In the case where the potential Va of the electrode 21a within the dummy chamber 2 is higher than the potential Vb of the electrode 21b within the pressure chamber 1, that is, in the case where Va>Vb, the liquid ejection device according to this modification example also conducts the same operation as the operation of the liquid ejection device according to the embodiment described above with reference to FIG. 8A and FIG. 8B. Specifically, in the region 18 on the front surface side of the piezoelectric transducer 10, the partition 3 is displaced so that the cross sectional area of the pressure chamber 1 decreases. On the other hand, in the region 19 on the back surface side of the piezoelectric transducer 10, the partition 3 is displaced so that the cross sectional area of the pressure chamber 1 increases.

In the case where the potential Va of the electrode 21a within the dummy chamber 2 is lower than the potential Vb of the electrode 21b within the pressure chamber 1, that is, in the case where Va<Vb, the liquid ejection device according to this modification example also conducts the same operation as the operation of the liquid ejection device according to the embodiment described above with reference to FIG. 9A and FIG. 9B. Specifically, in the region 18 on the front surface side of the piezoelectric transducer 10, the partition 3 is displaced so that the cross sectional area of the pressure chamber 1 increases. On the other hand, in the region 19 on the back surface side of the piezoelectric transducer 10, the partition 3 is displaced so that the cross sectional area of the pressure chamber 1 decreases.

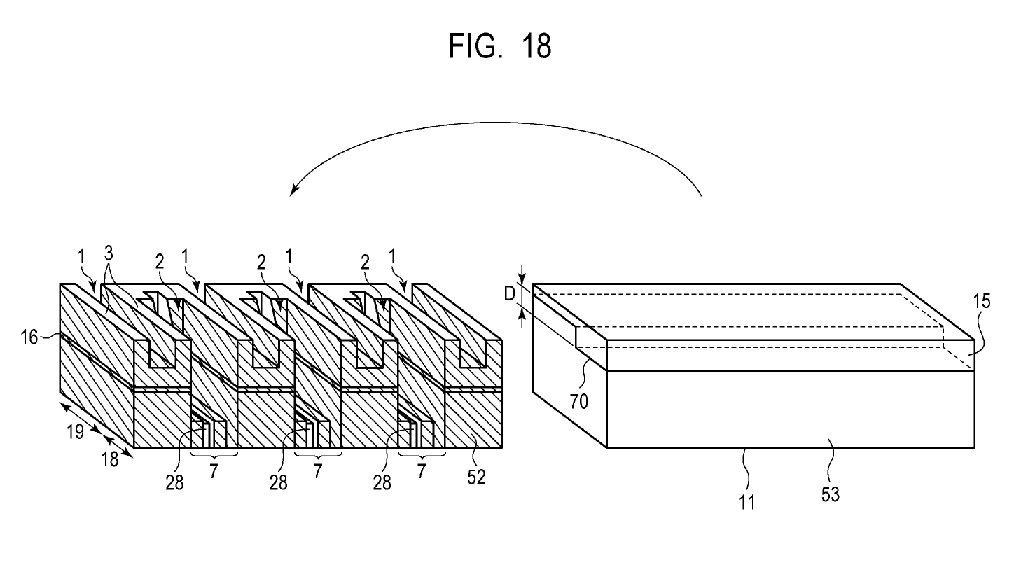

Next, a method of manufacturing a liquid ejection device according to this modification example is described with reference to FIG. 18. FIG. 18 is a process view for illustrating the method of manufacturing a liquid ejection device according to this modification example.

From a step of forming the piezoelectric plate 12 to a step of forming the separating grooves 20 and 28 are the same as those of the method of manufacturing a liquid ejection device described above with reference to FIG. 11 to FIG. 14, and hence descriptions thereof are omitted.

Subsequently, as illustrated in FIG. 18, in the region 18 (portion to be opposed to the first partition portion) on the front surface side (side to which the orifice plate 60 is mounted) of the cover plate 11, the cover plate 11 is partially removed. This causes a recess (groove or step) 70 to be formed in the region 18 on the front surface side of the cover plate 11, to form a recess retracted from the region 19 (portion to be opposed to the second partition portion) on the back surface side (side to which the manifold 40 is mounted) of the cover plate 11. In FIG. 18, a depth D of the recess 70 indicates a height of the step. The recess can be formed by using, for example, the diamond blade or the like.

In other words, a plate is prepared, in which a recess is formed so that the portion to be opposed to the first partition portion is retracted from the portion to be opposed to the second partition portion.

Subsequently, the adhesive layer 15 is applied on the cover plate 11 in which the recess 70 is formed. In this case, the adhesive layer 15 is formed so that the upper surface of the adhesive layer 15 in the region 18 on the front surface side of the cover plate is matched in level with the upper surface of the adhesive layer 15 in the region 19 on the back surface side (side to which the manifold 40 is mounted) of the cover plate 11. As described above, the recess 70 is formed in the region on the front surface side of the cover plate 11. Therefore, the thickness of the adhesive layer 15 in the region on the front surface side of the cover plate 11 is larger than the thickness of the adhesive layer 15 in the region on the back surface side of the cover plate 11 by the depth D of the recess 70.

Note that, a method of forming the adhesive layer 15 is not limited thereto.

For example, the adhesive layer 15 may be formed in the following manner. Specifically, first, the adhesive layer 15 is applied on an entire surface of the cover plate 11 so as to fill an inside of the recess 70 of the cover plate 11. After that, the adhesive layer 15 is cured. After that, the adhesive layer 15 is polished until the surface of the cover plate 11 is exposed in the region 19 on the back surface side of the cover plate 11. This causes the recess 70 of the cover plate 11 to be filled with the adhesive layer 15. After that, the adhesive layer 15 is further applied on the cover plate 11. Even when the adhesive layer 15 is thus formed, the thickness of the adhesive layer 15 in the region on the front surface side of the piezoelectric transducer 10 becomes larger than the thickness of the adhesive layer 15 in the region on the back surface side of the piezoelectric transducer 10.

Further, the adhesive layer 15 may be formed in the following manner. Specifically, first, the adhesive layer 15 is applied on the entire surface of the cover plate 11 so as to fill the inside of the recess 70 of the cover plate 11. After that, the adhesive layer 15 is cured. After that, the adhesive layer 15 is polished until the surface of the cover plate 11 is exposed in the region 19 on the back surface side of the cover plate 11. This causes the recess 70 of the cover plate 11 to be filled with the adhesive layer 15. On the other hand, the adhesive layer 15 is applied also on the piezoelectric plate 12 side. Specifically, the adhesive layer 15 is applied on the upper surface of the partition 3 of the piezoelectric plate 12. After that, the cover plate 11 and the piezoelectric plate 12 are aligned to be joined to each other. Even when the adhesive layer 15 is thus formed, the thickness of the adhesive layer 15 in the region 18 on the front surface side of the piezoelectric transducer 10 becomes larger than the thickness of the adhesive layer 15 in the region 19 on the back surface side of the piezoelectric transducer 10.

In the same manner as in the method of manufacturing a liquid ejection device according to the embodiment described above with reference to FIG. 15, the adhesive layer 15 can be directly applied by, for example, a screen printing method, a bar coating method, or an offset printing method. Further, after the adhesive layer 15 is applied on different substrates such as glass substrates by use of at least of one of those application methods, the adhesive layer 15 applied on the different substrates may be transferred onto the piezoelectric plate 12 and the cover plate 11.

The subsequent steps of the method of manufacturing a liquid ejection device are the same as those of the method of manufacturing a liquid ejection device described above with reference to FIG. 16 and FIG. 1, and hence descriptions thereof are omitted.

Note that, the present invention is not limited to the above-mentioned embodiment. Changes can be made thereto appropriately by a person who has common knowledge in this technical field within the scope that does not depart from the technical thought of the present invention.

Further, in the above-mentioned embodiment, the inkjet head to be used for a printer or the like is described as an example of the liquid ejection device, but the present invention is not limited thereto. For example, the liquid ejection device may be a liquid ejection device configured to eject liquid containing metal fine particles. When the liquid containing metal fine particles is ejected, it is possible to form metal wiring (metal pattern) or the like. Further, the liquid ejection device may be a liquid ejection device configured to eject resist liquid (resist ink). When the resist liquid is ejected, it is possible to form a resist pattern.

### EXAMPLES

Next, more specific examples of the present invention are described.

### Example 1

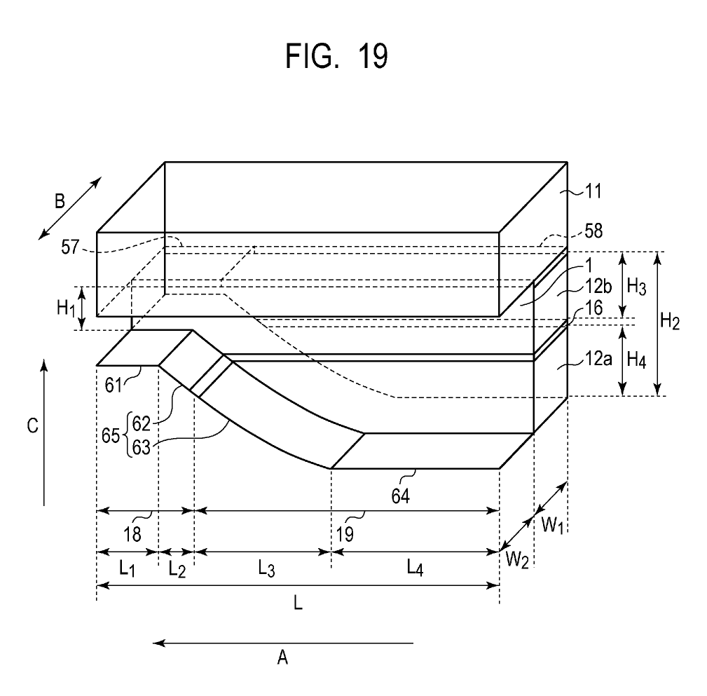

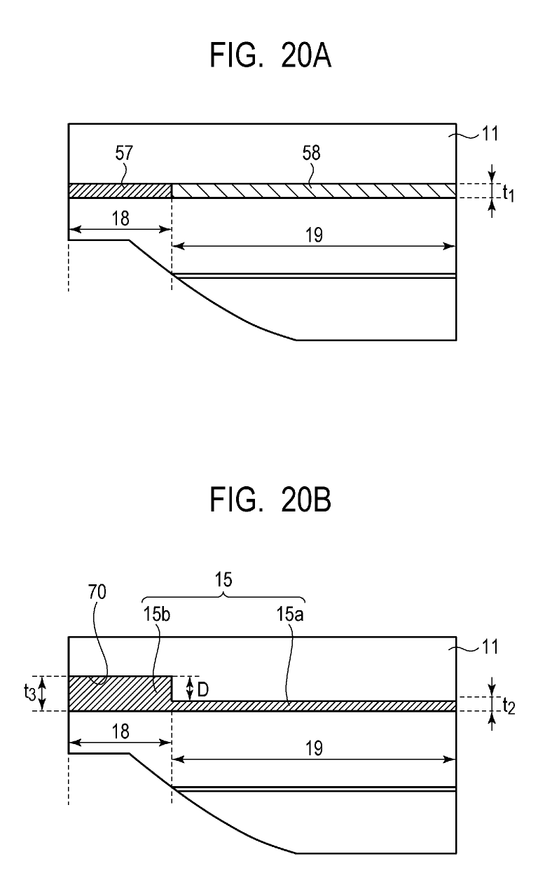

First, Example 1 is described with reference to FIG. 19 and FIG. 20A. FIG. 19 is a perspective view for illustrating a part of a piezoelectric transducer of a liquid ejection device according to Example 1. Example 1 corresponds to the liquid ejection device according to the embodiment described above with reference to FIG. 1 to FIG. 16.

In Example 1, the groove 1 was formed by being subjected to processing using the diamond blade. Therefore, in Example 1, the pressure chamber 1 was set to partially have a tapered shape. In Example 1, a flat portion 61 that is a part having a flat bottom surface of the pressure chamber 1 was formed in the region 18 on the front surface side (left side of the drawing sheet of FIG. 18) of the piezoelectric transducer 10. Further, in Example 1, a flat portion 64 that is a part having a flat bottom surface of the pressure chamber 1 was formed in the region 19 other than the region 18 on the front surface side of the piezoelectric transducer 10, that is, in the region 19 of the back surface side of the piezoelectric transducer 10 (right side of the drawing sheet of FIG. 18). Further, in Example 1, a tapered portion 65 that is a part having a tapered bottom surface of the pressure chamber 1 was formed between the flat portion 61 and the flat portion 64. In Example 1, a partial tapered portion 62 that is a part of the tapered portion 65 is positioned in the region 18 on the front surface side of the piezoelectric transducer 10. On the other hand, in Example 1, a partial tapered portion 63 that is another part of the tapered portion 65 is positioned in the region 19 on the back surface side of the piezoelectric transducer 10.

In Example 1, a dimension L of the pressure chamber 1 in the longitudinal direction, that is, a length L of the pressure chamber 1 was set to 8 mm. Further, in Example 1, a length L₁ of the flat portion 61 in the region 18 on the front surface side of the piezoelectric transducer 10 was set to 0.5 mm. Further, in Example 1, a length L₂ of the partial tapered portion 62 in the region 18 on the front surface side of the piezoelectric transducer 10 was set to 1.1 mm. Further, in Example 1, a length L₃ of the partial tapered portion 63 in the region 19 on the back surface side of the piezoelectric transducer 10 was set to 2.8 mm. Further, in Example 1, a length L₄ of the flat portion 64 in the region 19 on the back surface side of the piezoelectric transducer 10 was set to 3.6 mm.

The direction indicated by the arrow C of FIG. 19 corresponds to a height direction. In Example 1, a height H₁ from the bottom surface of the pressure chamber 1 to the upper surface of the partition 3 in the flat portion 61 in the region 18 on the front surface side of the piezoelectric transducer 10 was set to 100 μm. Further, in Example 1, a height H₂ from the bottom surface of the pressure chamber 1 to the upper surface of the partition 3 in the flat portion 64 in the region 19 on the back surface side of the piezoelectric transducer 10 was set to 300 μm. Further, in Example 1, a height H₄ from the bottom surface of the pressure chamber 1 to the upper surface of the piezoelectric member 12a in the flat portion 64 in the region 19 on the back surface side of the piezoelectric transducer was set to 150 μm. Further, in Example 1, a height H₃ of the piezoelectric member 12b in the flat portion 64 in the region 19 on the back surface side of the piezoelectric transducer 10 was set to 150 μm.

Further, in Example 1, a dimension W₁ of the partition 3 in a direction indicated by an arrow B of FIG. 19, that is, a width (thickness) W₁ of the partition 3 was set to 60 μm. Further, in Example 1, a dimension W₂ of the pressure chamber 1 in the direction indicated by the arrow B of FIG. 19, that is, the width W₂ of the pressure chamber 1 was set to 60 μm.

FIG. 20A is a sectional view for illustrating a part of the piezoelectric transducer of the liquid ejection device according to Example 1.

As illustrated in FIG. 20A, in the region 18 on the front surface side of the piezoelectric transducer 10, the cover plate 11 and the piezoelectric plate 12 were joined to each other with the adhesive layer 57. As the adhesive layer 57, a one-pack epoxy resin (product number: EF-328) manufactured by Sanyu Rec Co., Ltd. was used. The elastic coefficient of the adhesive layer 57 was 200 MPa.

On the other hand, in the region 19 on the back surface side of the piezoelectric transducer 10, the cover plate 11 and the piezoelectric plate 12 were joined to each other with the adhesive layer 58. As the adhesive layer 58, a one-pack epoxy resin (product number: B-1077B) manufactured by TESK CO., LTD. was used. The elastic coefficient of the adhesive layer 58 was 1,000 MPa.

A thickness t₁ of each of the adhesive layers 57 and 58 was set to 2 μm.

After that, the manifold 40, the orifice plate 60, the flexible substrate 50, and the like were mounted, to obtain the liquid ejection device according to Example 1.

The liquid ejection device according to Example 1 was evaluated by being caused to eject liquid. As the liquid to be ejected in the evaluation, an ethylene glycol solution diluted with water was used. A density of ethylene glycol within the liquid was set to 80 wt %. When the liquid was ejected from the liquid ejection device according to Example 1, voltages to be applied to the electrodes 21a and 21b were set as follows. That is, the electrode 21b has a potential of 0 V. On the other hand, a pulse-like signal having a positive voltage was applied to the electrode 21a. The signal to be applied to the electrode 21a was set to have a pulse width of 8 μs. An imaging apparatus to which a microscope was attached was used to pick up an image of a liquid droplet in a flying state. As a light source used for picking up the image of the liquid droplet in the flying state, a light source configured to emit nanopulse laser light was used.

As the voltage of the pulse-like signal to be applied to the electrode 21a was increased, the speed of the liquid droplet increased. When the speed of the liquid droplet (main droplet) became equal to or larger than a given speed, a minute liquid droplet (satellite droplet) separate from the main droplet was generated before the main droplet. When the satellite droplet began to be generated, the speed of the main droplet differed depending on a diameter of the nozzle 60a. The speed of the main droplet exhibited when the satellite droplet began to be generated is shown in Table 1.

In Comparative Example 1, the same adhesive layer 58 is used to join the piezoelectric plate 12 and the cover plate 11 to each other both in the region 19 on the back surface side of the piezoelectric transducer 10 and in the region 18 on the front surface side of the piezoelectric transducer 10. In Comparative Example 1, as the adhesive layer 58, the one-pack epoxy resin (product number: B-1077B) manufactured by TESK CO., LTD. was used. In Comparative Example 1, the elastic coefficient of the adhesive layer 58 was 1,000 MPa. In Comparative Example 1, the thickness of the adhesive layer 58 was set to 2 μm.

TABLE 1

| | Φ5 μm | Φ7 μm | Φ10 μm | Φ12 μm | Φ15 μm |
|---|---|---|---|---|---|
| Example 1 | 2 m/s | 3 m/s | 4 m/s | 5 m/s | 6 m/s |
| Comparative | 0.2 m/s | 0.5 m/s | 1 m/s | 3 m/s | 4.5 m/s |
| Example 1 | | | | | |

As can be seen from Table 1, in Comparative Example 1, when the diameter of the nozzle 60a was set to be relatively small, the satellite droplet was generated even with a relatively low speed of the liquid droplet.

In contrast, in Example 1, even when the diameter of the nozzle 60a was relatively small and when the speed of the liquid droplet was relatively high, the satellite droplet was hardly generated.

In Comparative Example 1, it is conceivable that, when the diameter of the nozzle 60a is set to be relatively small, the satellite droplet is generated even when the speed of the liquid droplet is relatively low for the following reason. Specifically, in Comparative Example 1, also in the region 18 on the front surface side of the piezoelectric transducer 10, the partition 3 is fixed to the cover plate 11 with the adhesive layer 58 having a relatively high elastic coefficient. Therefore, in Comparative Example 1, in the region 18 on the front surface side of the piezoelectric transducer 10, the partition 3 is hardly displaced. Therefore, in Comparative Example 1, when the partial pressure chamber 1a (see FIG. 10A to FIG. 10E) is contracted in the region 19 on the back surface side of the piezoelectric transducer 10, the partial pressure chamber 1b is not expanded in the region 18 on the front surface side of the piezoelectric transducer 10. Therefore, in Comparative Example 1, when the partial pressure chamber 1a is contracted in the region on the back surface side of the piezoelectric transducer 10, the pressure of the liquid suddenly concentrates into the nozzle 60a. Therefore, in Comparative Example 1, it is conceivable that, when the diameter of the nozzle 60a is set to be relatively small, the satellite droplet is generated even with a relatively low speed of the liquid droplet.

In Example 1, in the region 18 on the front surface side of the piezoelectric transducer 10, the partition 3 is fixed to the cover plate 11 by use of the adhesive layer 57 having a relatively low elastic coefficient, and hence the partition 3 can be displaced in the region 18 on the front surface side of the piezoelectric transducer 10. Therefore, in Example 1, when the partial pressure chamber 1a is contracted in the region 19 on the back surface side of the piezoelectric transducer 10, the partial pressure chamber 1b is expanded in the region 18 on the front surface side of the piezoelectric transducer 10. Therefore, according to Example 1, when the partial pressure chamber 1a is contracted in the region 19 on the back surface side of the piezoelectric transducer 10, it is possible to alleviate the concentration of the pressure of the liquid into the nozzle 60a. Therefore, according to Example 1, even when the diameter of the nozzle 60a is set to be relatively small and when the speed of the liquid droplet is set to be relatively high, it is possible to prevent the satellite droplet from being easily generated.

### Example 2

Next, Example 2 is described with reference to FIG. 20B. FIG. 20B is a sectional view for illustrating a part of a piezoelectric transducer of a liquid ejection device according to Example 2.

Example 2 corresponds to the liquid ejection device according to the modification example of the embodiment described above with reference to FIG. 17A to FIG. 18. Example 2 is the same as Example 1 except that the thickness of the adhesive layer 15 is set to be relatively large in the region 18 on the front surface side of the piezoelectric transducer 10.

In FIG. 20B, an adhesive layer 15a indicates an adhesive layer used in the region 19 on the back surface side of the piezoelectric transducer 10. In FIG. 20B, an adhesive layer 15b indicates an adhesive layer used in the region 18 on the front surface side of the piezoelectric transducer 10. In Example 2, the adhesive layer 15a to be used in the region 19 on the back surface side of the piezoelectric transducer 10 and the adhesive layer 15b to be used in the region 18 on the front surface side of the piezoelectric transducer 10 were adhesive layers having the same material. In Example 2, the adhesive layer 15a and the adhesive layer 15b were formed integrally.

A thickness t₂ of the adhesive layer 15 in the region 19 on the back surface side of the piezoelectric transducer 10, that is, the thickness t₂ of the adhesive layer 15a was set to 2 μm.

A thickness t₃ of the adhesive layer 15 in the region 18 on the front surface side of the piezoelectric transducer 10, that is, the thickness t₃ of the adhesive layer 15b was set to 12 μm.

The depth D of the recess 70 in the cover plate 11 was set to 10 μm.

As the adhesive layer 15, that is, as the adhesive layers 15a and 15b, the one-pack epoxy resin (product number: B-1077B) manufactured by TESK CO., LTD. was used. The elastic coefficient of the adhesive layer 15 was 1,000 MPa.

The thus-obtained liquid ejection device according to Example 2 was evaluated in the same manner as in Example 1. The speed of the main droplet exhibited when the satellite droplet began to be generated in the liquid ejection device according to Example 2 is shown in Table 2.

TABLE 2

| | Φ5 μm | Φ7 μm | Φ10 μm | Φ12 μm | Φ15 μm |
|---|---|---|---|---|---|
| Example 2 | 2 m/s | 3 m/s | 3.5 m/s | 4.5 m/s | 6 m/s |

As can be seen from a comparison between Table 1 and Table 2, also in Example 2, substantially the same performance as in Example 1 is obtained.

It is conceivable that the results of evaluation of Example 2 is substantially the same as the results of evaluation of Example 1 because the partition 3 can be displaced also in Example 2 in the same manner as in Example 1 in the region 18 on the front surface side of the piezoelectric transducer 10.

### Example 3

Next, Example 3 is described with reference to FIG. 20B.

Example 3 corresponds to the liquid ejection device according to the modification example of the embodiment described above with reference to FIG. 17A to FIG. 18. Example 3 is the same as Example 2 except for the material and the thickness of the adhesive layer 15b in the region 18 on the front surface side of the piezoelectric transducer 10.

The adhesive layer 15b to be used in the region on the front surface side of the piezoelectric transducer 10 was selected from three kinds of adhesive having different elastic moduli E₁. As the adhesive layer 15b having an elastic modulus E₁ of 1,000 MPa, the one-pack epoxy resin (product number: B-1077B) manufactured by TESK CO., LTD. was used. As the adhesive layer 15b having an elastic modulus E₁ of 200 MPa, the one-pack epoxy resin (product number: EF-328) manufactured by Sanyu Rec Co., Ltd. was used. As the adhesive layer 15b having an elastic modulus E₁ of 20 MPa, the one-pack epoxy resin (product number: EF-288) manufactured by Sanyu Rec Co., Ltd. was used.

As the adhesive layer 15a to be used in the region 19 on the back surface side of the piezoelectric transducer 10, an adhesive having an elastic modulus E₂ of 1,000 MPa was used. As the adhesive layer 15a, the one-pack epoxy resin (product number: B-1077B) manufactured by TESK CO., LTD. was used.

The diameter of the nozzle 60a was set to φ10 μm.

A ratio of the elastic modulus E₁ to the thickness t₃ of the adhesive layer 15b used in the region 18 on the front surface side of the piezoelectric transducer 10 is set as r₁. The ratio r₁ is expressed by the following expression. r₁=E₁/t₃

A ratio of the elastic modulus E₂ to the thickness t₂ of the adhesive layer 15a used in the region 19 on the back surface side of the piezoelectric transducer 10 is set as r₂. The ratio r₂ is expressed by the following expression. r₂=E₂/t₂

The ratio r₁ indicates a degree of rigidity of the adhesive layer 15b, and the ratio r₂ indicates a degree of rigidity of the adhesive layer 15a. As the value of r₁ becomes smaller, the rigidity of the adhesive layer 15b becomes smaller, and the value of r₂ becomes smaller, the rigidity of the adhesive layer 15a becomes smaller.

The speed of the main droplet exhibited when the satellite droplet began to be generated in the liquid ejection device according to Example 3 is shown in Table 3.

TABLE 3

| | | | | | | | | | |
|---|---|---|---|---|---|---|---|---|---|
| Adhesive | E₁ [MPa] | 1,000 | 1,000 | 1,000 | 200 | 200 | 20 | 20 | 20 |
| layer | t₃ [μm] | 2 | 7 | 12 | 17 | 32 | 7 | 17 | 22 |
| 15b | r₁ [MPa/μm] | 500 | 143 | 83 | 12 | 6 | 3 | 1 | 1 |
| Adhesive | E₂ [MPa] | 1,000 | 1,000 | 1,000 | 1,000 | 1,000 | 1,000 | 1,000 | 1,000 |
| layer | t₂ [μm] | 2 | 2 | 2 | 2 | 2 | 2 | 2 | 2 |
| 15a | r₂ [MPa/μm] | 500 | 500 | 500 | 500 | 500 | 500 | 500 | 500 |
| | r₂/r₁ | 1 | 4 | 6 | 43 | 80 | 175 | 425 | 550 |

| | | | | | | | | |
|---|---|---|---|---|---|---|---|---|
| Speed of liquid droplet | 0.1 | 0.5 | 3.5 | 5.5 | 5.5 | 5.5 | 5.5 | Unstable |
| [m/s] | | | | | | | | |

As can be seen from Table 3, as the ratio (r₂/r₁) of r₂ to r₁ became larger, the speed of the main droplet exhibited when the satellite droplet began to be generated became higher.

However, when the ratio (r₂/r₁) of r₂ to r₁ exceeded 500, the liquid droplet was not ejected stably. This is because influence of residual vibration of the partition 3 in the region 18 on the front surface side of the piezoelectric transducer 10 cannot be ignored when the rigidity of the adhesive layer 15b in the region 18 on the front surface side of the piezoelectric transducer 10 becomes too small.

In view of the above-mentioned observation, it is preferred that the ratio (r₂/r₁) of r₂ to r₁ be 5 or more and 500 or less.

According to the present invention, in the region on the back surface side of the piezoelectric transducer, the bottom surface of the pressure chamber is positioned in the position deeper than the boundary between the first piezoelectric member and the second piezoelectric member. On the other hand, in the region on the front surface side of the piezoelectric transducer, the bottom surface of the pressure chamber is positioned in the position shallower than the boundary between the first piezoelectric member and the second piezoelectric member. Further, on the front surface side of the piezoelectric transducer, the upper surface of the partition is fixed to the cover plate with the adhesive layer having a relatively low elastic coefficient or the relatively thick adhesive layer. Therefore, according to the present invention, in the region on the front surface side of the piezoelectric transducer, the partition can be displaced with reliability. Accordingly, when the pressure chamber is contracted in the region on the back surface side of the piezoelectric transducer, the pressure chamber can be expanded in the region on the front surface side of the piezoelectric transducer. Therefore, according to the present invention, when the liquid droplet is ejected by contracting the region on the back surface side of the piezoelectric transducer, it is possible to alleviate the sudden concentration of pressure into the nozzle, which can inhibit the satellite droplet from being generated. Consequently, according to the present invention, it is possible to provide the liquid ejection device capable of ejecting a minute liquid droplet with stability.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-184814, filed Sep. 11, 2014 which is hereby incorporated by reference herein in its entirety.

1. A liquid ejection device, comprising:
a base including:
a first piezoelectric member; and
a second piezoelectric member fixed to the first piezoelectric member and polarized in a direction opposite to a polarization direction of the first piezoelectric member;
a pressure chamber formed to the base and separated by at least two partitions formed of the first piezoelectric member and the second piezoelectric member and by a plate mounted on end surfaces of the at least two partitions; and
an electrode formed on both side surfaces of the at least two partitions, wherein:
the pressure chamber is narrow on a front surface side on which a discharge port configured to eject liquid is formed;
a surface of the at least two partitions that faces the pressure chamber includes:
a first partition portion formed of only the first piezoelectric member; and
a second partition portion formed of the first piezoelectric member and the second piezoelectric member;
the pressure chamber is separated by the first partition portion on the front surface side;
the pressure chamber is separated by the second partition portion on a back surface side on which a liquid chamber configured to supply the liquid to the pressure chamber is formed;
the end surface of the first partition portion is fixed to the plate with a first adhesive layer;
the end surface of the second partition portion is fixed to the plate with a second adhesive layer; and
an elastic coefficient of the first adhesive layer is smaller than an elastic coefficient of the second adhesive layer.

2. The liquid ejection device according to claim 1, wherein the elastic coefficient of the first adhesive layer is 10 MPa or more and 500 MPa or less.

3. The liquid ejection device according to claim 1 or 2, wherein
the elastic coefficient of the second adhesive layer is 500 MPa or more and 2,000 MPa or less.

4. A liquid ejection device, comprising:
a base including:
a first piezoelectric member; and
a second piezoelectric member fixed to the first piezoelectric member and polarized in a direction opposite to a polarization direction of the first piezoelectric member;
a pressure chamber formed to the base and separated by at least two partitions formed of the first piezoelectric member and the second piezoelectric member and by a plate mounted on end surfaces of the at least two partitions; and
an electrode formed on both side surfaces of the at least two partitions, wherein:
the pressure chamber is narrow on a front surface side on which a discharge port configured to eject liquid is formed;
a surface of the at least two partitions that faces the pressure chamber includes:
a first partition portion formed of only the first piezoelectric member; and
a second partition portion formed of the first piezoelectric member and the second piezoelectric member;
the pressure chamber is separated by the first partition portion on the front surface side;
the pressure chamber is separated by the second partition portion on a back surface side on which a liquid chamber configured to supply the liquid to the pressure chamber is formed;
the end surface of the first partition portion is fixed to the plate with a first adhesive layer;
the end surface of the second partition portion is fixed to the plate with a second adhesive layer; and
a thickness of the first adhesive layer is larger than a thickness of the second adhesive layer.

5. The liquid ejection device according to claim 4, wherein, when a ratio of an elastic coefficient of the first adhesive layer to the thickness of the first adhesive layer is set as r₁ and a ratio of an elastic coefficient of the second adhesive layer to the thickness of the second adhesive layer is set as r₂, a ratio of r₂ to r₁ is 5 or more and 500 or less.

6. A method of manufacturing a liquid ejection device, comprising:
forming a groove in a first piezoelectric member and a second piezoelectric member fixed to the first piezoelectric member and polarized in a direction opposite to a polarization direction of the first piezoelectric member, to thereby form a pressure chamber separated by a partition including a first partition portion obtained by cutting up to the first piezoelectric member and a second partition portion obtained by cutting from the first piezoelectric member up to the second piezoelectric member;
forming an electrode on the partition; and
bonding a plate to the partition,
wherein the bonding of the plate includes:
bonding the plate to the first partition portion with a first adhesive; and
bonding the plate to the second partition portion with a second adhesive.

7. The method of manufacturing a liquid ejection device according to claim 6, wherein a solidification-time elastic coefficient of the first adhesive is 10 MPa or more and 500 MPa or less.

8. The method of manufacturing a liquid ejection device according to claim 6, wherein a solidification-time elastic coefficient of the second adhesive is 500 MPa or more and 2,000 MPa or less

9. A method of manufacturing a liquid ejection device, comprising:
forming a groove in a first piezoelectric member and a second piezoelectric member fixed to the first piezoelectric member and polarized in a direction opposite to a polarization direction of the first piezoelectric member, to thereby form a pressure chamber separated by a partition including a first partition portion obtained by cutting up to the first piezoelectric member and a second partition portion obtained by cutting from the first piezoelectric member up to the second piezoelectric member;
forming an electrode on the partition;
preparing a plate having a recess formed such that a part of the recess opposed to the first partition portion is retracted from a part of the recess opposed to the second partition portion; and
bonding the plate to the partition.

10. A printer, comprising the liquid ejection device of claim 1.

11. A printer, comprising the liquid ejection device of claim 4.
